(19) United States
(12) Patent Application Publication
(10) Pub. No.: US 2016/0316061 A1
(43) Pub. Date: Oct. 27, 2016

(54) METHOD AND SYSTEM FOR LEAVING MESSAGES

(71) Applicant: BEIJING QIHOO TECHNOLOGY COMPANY LIMITED, xicheng District, Beijing (CN)

(72) Inventors: Jiang ZHAO, Chaoyang District, Beijing (CN); Meng WANG, Chaoyang District, Beijing (CN); Pengfei LI, Chaoyang District, Beijing (CN)

(73) Assignee: BEIJING QIHOO TECHNOLOGY COMPANY LIMITED, xicheng District, Beijing (CN)

(21) Appl. No.: 15/101,637

(22) PCT Filed: Sep. 12, 2014
(86) PCT No.: PCT/CN2014/086403

§ 371 Date: Jun. 3, 2016

(30) Foreign Application Priority Data
Dec. 6, 2013 (CN) 20130657136.5

(51) Int. Cl. H04M 3/533; H04M 3/53; H04L 29/08; H04M 7/00

(52) U.S. Cl. CPC H04M 3/53333; H04M 7/006; H04M 3/53383; H04M 3/5322; H04L 67/1085; H04W 88/02

(57) ABSTRACT

The present application relates to the technical field of communications. Disclosed are a method and system for leaving messages. The method comprises:after a user starts a call process, monitoring a connection process of a call made from a calling terminal to a called terminal, and determining whether the call is connected; triggering a message-inputting interface in the calling terminal when the call is not connected; receiving a message input of a user and generating message data; and uploading the message data in the calling terminal onto a server via an Internet Protocol, and providing the message data to the called terminal for playing or downloading.

### CROSS-REFERENCE TO RELATED APPLICATIONS

This application is the national stage of International Application No. PCT/CN2014/086403 filed Sep. 12, 2014 which is based upon and claims priority to Chinese Patent Application No. CN201310657136.5, filed Dec. 6, 2013, the entire contents of all of which are incorporated herein by reference.

### FIELD OF THE DISCLOSURE

The disclosure relates to the field of communication technology, and particularly to a method and system for leaving a message.

### BACKGROUND OF THE DISCLOSURE

When a user makes a call by a phone, a called user may not answer the call in time due to various reasons. After the calling user hangs up or the called user rejects answering the call, both the calling user and the called user are unable to know an intention which the call expresses, which results in miscommunication, thereby causing confusion and misunderstanding. In this case, the user can use a function of short message and multimedia message of a cell phone system in a case of wanting to leave a message to the called user, however, this process is cumbersome.

For example, in a case that the short message is used to leave a message, operation steps thereof include:

[1] exiting a phone program and clicking on an icon to enter a short message program;

[2] editing a short message;

[3] selecting and clicking on a phone number of a called user to send the short message; For example, in a case that the multimedia message is used to leave a message, operation steps thereof include:

[1] exiting a phone program and entering a multimedia program to record voice in a case that a multimedia message is used to send a voice information;

[2] returning to an interface of a short message to add the recorded voice into the multimedia message in a form of attachment, selecting and clicking on a phone number of a called user to send the multimedia message;

[3] after the multimedia message is sent, clicking on a multimedia program to enter the multimedia program and playing the voice by a receiving part after the multimedia message is downloaded.

An operation of the process described above is cumbersome for a cell phone user. In addition, since data transmission amount of one short message or one multimedia message is limited, multiple short messages or multiple multimedia messages are sent in a case that content sent by a calling terminal is large, thereby increasing fees, and especially that the fees for the multimedia message is high. Also, in the case described above, the multiple short messages and the multiple multimedia messages are received by a called terminal, thereby having a cumbersome operation.

### SUMMARY OF THE DISCLOSURE

In view of aforesaid problems, the disclosure provides a system and a method for leaving a message, to overcome the aforesaid problems or at least partially solve the aforesaid problems.

A method for leaving a message is provided in the disclosure, which includes:

after a user starts a call process, monitoring a connection process of a call made from a calling terminal to a called terminal, and determining whether the call is connected;

triggering a message-inputting interface in the calling terminal when the call is not connected;

receiving a message input of a user and generating message data; and

uploading the message data in the calling terminal onto a server via an Internet Protocol, and providing the message data to the called terminal for playing or downloading.

A terminal for leaving a message is provided in the disclosure, which includes:

one or more processors; and

a memory;

wherein one or more programs are stored in the memory, and when executed by the one or more processors, the one or more programs cause the one or more processors to:

after a user starts a call process, monitoring a connection process of a call made from the terminal to a called terminal, and determining whether the call is connected, wherein the terminal is configured to be a calling terminal;

triggering a message-inputting interface in the calling terminal when the call is not connected;

receiving a message input of a user and generating message data; and

uploading the message data in the calling terminal onto a server via an Internet Protocol, and providing the message data to the called terminal for playing or downloading.

A system for leaving a message is provided in the disclosure, which includes a calling terminal, a called terminal and a server; the calling terminal comprises one or more processors and a memory,

wherein one or more programs are stored in the memory, and when executed by the one or more processors, the one or more programs cause the one or more processors to:

after a user starts a call process, monitoring a connection process of a call made from the terminal to a called terminal, and determining whether the call is connected, the terminal being a calling terminal;

triggering a message-inputting interface in the calling terminal when the call is not connected;

receiving a message input of a user and generating message data; and

uploading the message data in the calling terminal onto a server via an Internet Protocol, and providing the message data to the called terminal for playing or downloading.

A method for leaving a message is provided in the disclosure, which includes:

after a user starts a call process, monitoring a connection process of a call made from a calling terminal to a called terminal, and determining whether the call is connected;

triggering a voice-recording interface in the calling terminal when that the call is not connected;

receiving a voice input of the user and generating audio data; and

uploading the audio data in the calling terminal onto a server via an Internet Protocol, and providing the audio data to the called terminal for playing or downloading.

A system for leaving a message is further provided, which includes:

a call monitoring module, configured to, after a user starts a call process, monitor a connection process of a call made from a calling terminal to a called terminal, and determine whether the call is connected;

a voice-recording interface starting module, configured to trigger a voice-recording interface in the calling terminal when the call is not connected;

a voice-recording module, configured to receive a voice input of the user and generate audio data; and

a recorded voice data sending module, configured to upload the audio data in the calling terminal onto a server via the Internet Protocol, wherein the server provides the audio data to the called terminal for playing or downloading.

A system for leaving a message is further provided, which includes:

a calling terminal, a called terminal and a server; where

the calling terminal includes:
a call monitoring module, configured to, after a user starts a call process, monitor a connection process of a call made from a calling terminal to a called terminal, and determine whether the call is connected;
a voice-recording interface starting module, configured to trigger a voice-recording interface in the calling terminal when the call is not connected;
a voice-recording module, configured to receive a voice input of the user and generate audio data; and

a recorded voice data sending module, configured to, after the user determines to send the audio data to the called terminal, upload the audio data onto a server via the Network Data Protocol, where the server provides the audio data to the called terminal for playing or downloading.

A method for leaving a message is further provided, which includes:

after a user starts a call process, monitoring a connection process of a call made from a calling terminal to a called terminal, and determining whether the call is connected;

triggering a photographing interface in the calling terminal when the call is not connected;

receiving a photographing input of the user and generating video data or photo data; and

uploading the video data or the photo data in the calling terminal onto a server via the Internet Protocol, and providing the message data to the called terminal for playing or downloading.

A method for leaving a message is further provided, which includes:

after a user starts a call process, monitoring a connection process of a call made from a calling terminal to a called terminal, and determining whether the call is connected;

triggering a text-editing function in the calling terminal when the call is not connected;

receiving a text input of the user and generating text data; and

uploading the text data in the calling terminal onto a server via the Internet Protocol, and providing the message data to the called terminal for playing or downloading.

In the method for leaving a message according to the disclosure, a connection process of a call made from a calling terminal to a called terminal is monitored after a user starts a call process, whether the call is connected is determined, and a voice-recording interface in the calling terminal is triggered to record voice in a case that the call is not connected, the audio data in the calling terminal is uploaded onto a server via the Internet Protocol, so that the server provides the audio data to the called terminal to play or download. In addition, the server can provide a video, a photo or a text to the called terminal to play or download in a similar manner, thereby solving problems that an operation of the user is cumbersome in a case that a short message or a multimedia message is used by the user to leave a message and that fees may be high, achieving beneficial effects of simplifying an operation process and reducing a possibility of high fees by performing data transmission via the Internet.

Above description is only a summary of the technical scheme of the disclosure. In order to know the technical means of the disclosure more clearly so that it can be put into effect according to the content of the description, and to make aforesaid and other purpose, features and advantages of the disclosure clearer, the embodiments of the disclosure are listed below.

### BRIEF DESCRIPTION OF THE DRAWINGS

By reading the detailed description of the preferably selected embodiments below, various other advantages and benefits become clear for a person of ordinary skill in the art. The drawings are only used for showing the purpose of the preferred embodiments and are not intended to limit the present invention. And in the whole drawings, same drawing reference signs are used for representing same components. In the drawings:

FIG. 1 shows a schematic flow diagram of a method for leaving a message according to an embodiment of the disclosure;

FIG. 1a shows an exemplary interface of a triggered voice interface according to an embodiment of the disclosure;

FIG. 1b shows an exemplary interface of a voice-recording process according to an embodiment of the disclosure;

FIG. 1c shows an exemplary interface of waiting for sending recorded voice according to an embodiment of disclosure;

FIG. 1d shows an exemplary interface of a recorded voice sending process according to an embodiment of disclosure;

FIG. 1e shows an exemplary interface in which the recorded voice is sent successfully according to an embodiment of disclosure;

FIG. 1f shows an exemplary interface in which the voice is played in a called terminal according to an embodiment of disclosure;

FIG. 1g shows an exemplary interface in which the voice is played in a web page according to an embodiment of disclosure;

FIG. 2 shows a schematic flow diagram of a method for leaving a message according to an embodiment of the disclosure;

FIG. 3 shows a schematic flow diagram of a method for leaving a message according to an embodiment of the disclosure;

FIG. 4 shows a schematic flow diagram of a method for leaving a message according to an embodiment of the disclosure;

FIG. 5 shows a schematic flow diagram of a method for leaving a message according to an embodiment of the disclosure;

FIG. 6 shows a schematic flow diagram of a method for leaving a message according to an embodiment of the disclosure;

FIG. 7 shows a schematic flow diagram of a method for leaving a message according to an embodiment of the disclosure;

FIG. 8 shows a schematic flow diagram of a method for leaving a message according to an embodiment of the disclosure;

FIG. 9 shows a schematic flow diagram of a method for leaving a message according to an embodiment of the disclosure;

FIG. 10 shows a schematic flow diagram of a method for leaving a message according to an embodiment of the disclosure;

FIG. 11 shows a schematic flow diagram of a method for leaving a message according to an embodiment of the disclosure;

FIG. 12 shows a schematic flow diagram of a method for leaving a message according to an embodiment of the disclosure;

FIG. 13 shows a schematic structural diagram of a device for leaving a message according to an embodiment of the disclosure;

FIG. 14 shows a schematic structural diagram of a device for leaving a message according to an embodiment of the disclosure;

FIG. 15 shows a schematic structural diagram of a device for leaving a message according to an embodiment of the disclosure;

FIG. 16 shows a schematic structural diagram of a device for leaving a message according to an embodiment of the disclosure;

FIG. 17 shows a schematic structural diagram of a device for leaving a message according to an embodiment of the disclosure;

FIG. 18 shows a schematic structural diagram of a device for leaving a message according to an embodiment of the disclosure;

FIG. 19 shows a schematic structural diagram of a device for leaving a message according to an embodiment of the disclosure;

FIG. 20 shows a schematic structural diagram of a device for leaving a message according to an embodiment of the disclosure;

FIG. 21 shows a schematic structural diagram of a device for leaving a message according to an embodiment of the disclosure;

FIG. 22 shows a schematic structural diagram of a device for leaving a message according to an embodiment of the disclosure;

FIG. 23 shows a schematic structural diagram of a device for leaving a message according to an embodiment of the disclosure;

FIG. 24 shows a schematic structural diagram of a device for leaving a message according to an embodiment of the disclosure;

FIG. 25 shows a schematic structural diagram of a device for leaving a message according to an embodiment of the disclosure;

FIG. 26 shows schematically a block diagram of an electronic device for implementing the method according to the disclosure; and

FIG. 27 shows schematically a schematic diagram of a storage unit for storing or carrying program code for implementing the method according to the disclosure.

### EMBODIMENTS

The exemplified embodiments of the disclosure are described in detail below with reference to the drawings. Although the exemplified embodiments of the disclosure are shown in the drawings, it can be understood that the disclosure can be implemented in various ways other than the exemplified embodiments described here. Contrarily, the exemplified embodiments are provided to fully understand the disclosure, and the scope of the disclosure can be conveyed to those skilled in the art completely.

### First Embodiment

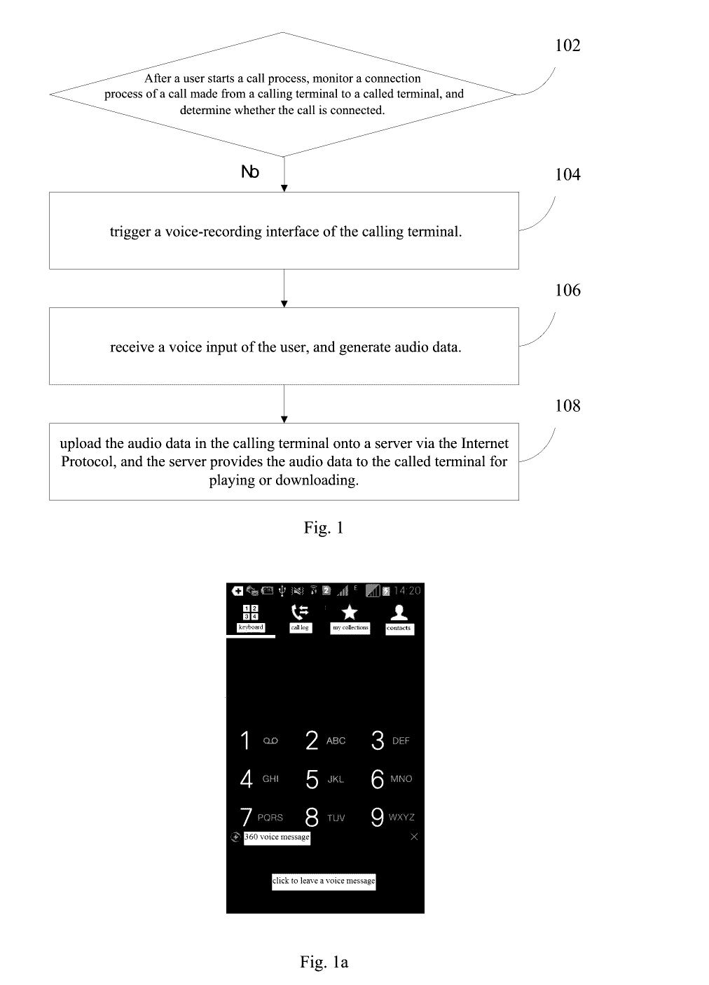

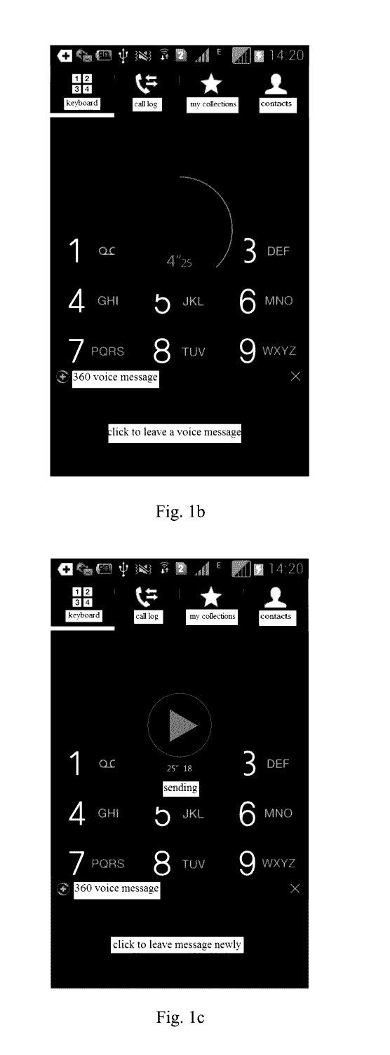

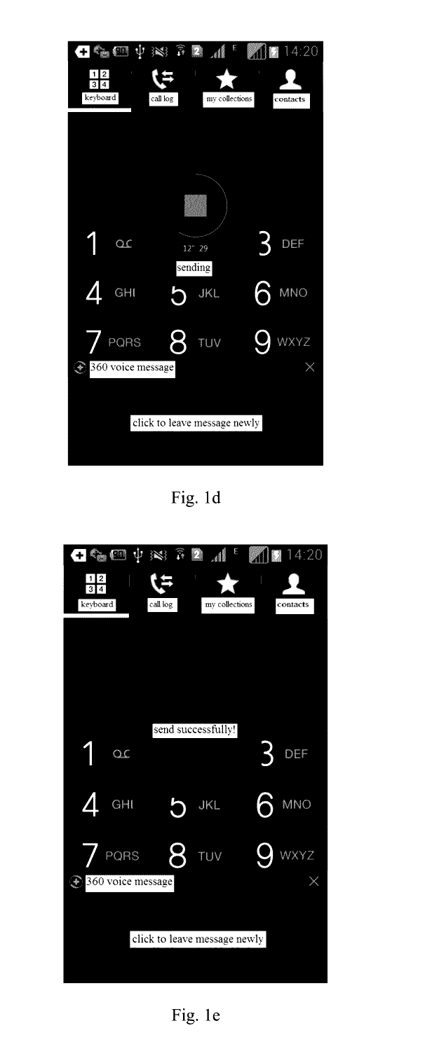

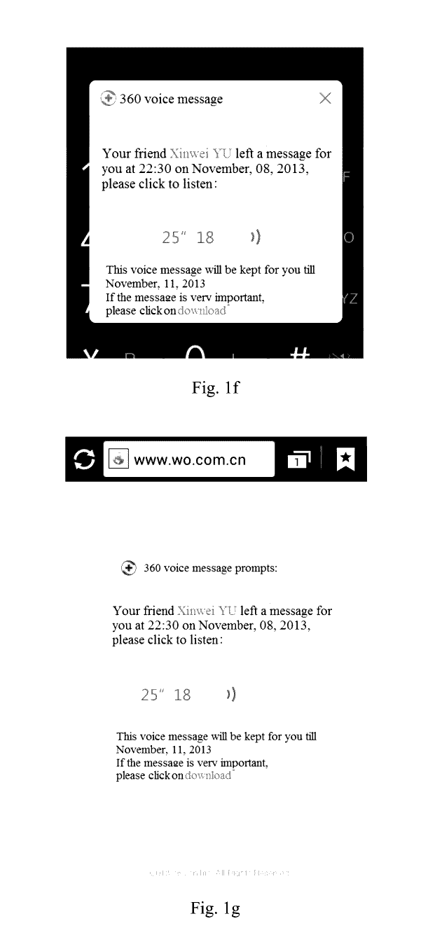

With reference to FIG. 1, which is a schematic flow diagram of a method for leaving a message according to disclosure, the method includes steps 102 to 108.

In step 102, after a user starts a call process, a connection process of a call made from a calling terminal to a called terminal is monitored, and whether the call is connected is determined; and step 104 is entered in a case that the call is not connected.

In the embodiment of the disclosure, in a case that the user of the calling terminal makes a call, the connection process of the call from the calling terminal can be monitored, and whether the call is connected is determined, the monitoring the connection process is ended in a case that the call is connected. A shortcut message-leaving function provided in the disclosure is triggered in a case that the call is not connected.

In practice, in the embodiment of the disclosure, it is regarded that the call is not connected in a case that a user of the called terminal hangs up initiatively, then step 104 is entered. Also, it is regarded that the call is not connected in a case that the user of the calling terminal hangs up initiatively. In this case, whether a time length of the connection process exceeds a threshold can be determined, and step 104 is entered in a case that the time length exceeds the threshold.

Preferably, after a user starts a call process, a connection process of a call made from a calling terminal to a called terminal is monitored, and whether the call is connected is determined includes step A10.

In step A10, a phone management API of a system is called to monitor a voice service in a connection management sub layer of the GSM protocol or in an upper entity of the CDMA, and whether the call is connected is determined.

In the embodiment of the disclosure, a conventional phone communication is monitored, that is, a call function of the cell phone is monitored. For example, in an android system, a phone management API (Application Program Interface) provided by the android system is called to monitor a voice service in a connection management sub layer of the GSM (Global System for Mobile Communication) protocol or in an upper entity of the CDMA (Code Division Multiple Access) 2000. In a case that it is learned that a call is dialed and then hanged up, a time length from dialing the call to hanging up the call is recorded in the voice service in the connection management sub layer or in the upper entity of the CDMA 2000 described above, a call record database of the system is queried, to check whether a value in an answering field of the call in the database represents that the call is connected. In a case that the call is not connected and the user waits for a time length greater than 15 s, the user is prompted to leave a message, and step 104 is triggered.

Alternatively, in an iOS system (a handset device operating system developed by the Apple Inc), similarly, a phone management API (Application Program Interface) provided by the iOS system is called to monitor a voice service in a connection management sub layer of the GSM protocol or in an upper entity of the CDMA 2000, the phone management API of the iOS system can monitor whether the call is connected, therefore, processing in the iOS system is simpler compared with the android system (an open-source operating system on a basis of Linux and JAVA), which only needs that the API is used to monitor a process from dialing the call to hanging up the call, and if the call is not connected, the user is prompted to leave a message in a case that a time length of the process exceeds 15 s.

Preferably, in a case that the call is not connected, step 102 further includes step A12.

In step A12, call duration for the call which is not connected is acquired, and it is determined whether the call duration exceeds a threshold, step 104 is entered in a case that the duration exceeds the threshold.

For example, in a case that the threshold is 15 s described above, and a voice-recording interface of the calling terminal is not triggered in a case that the call duration does not exceed 15 s. Step 104 is entered in a case that the call duration exceeds 15 s.

In step 104, the voice-recording interface of the calling terminal is triggered.

After it is determined in steps described above that the call made by the calling terminal is not connected (further it is determined whether the time length from dialing the call to hanging up the call exceeds the threshold), the voice-recording interface of the calling terminal is triggered.

In the embodiment of the disclosure, in a case that the user uses a terminal such as a cell phone to make a call, a call management interface for making a call is accessed, that is, the calling terminal performs a call-dialing action in a call management process. In a case that it is monitored that the call dialed by the user is not connected, the voice-recording interface of the calling terminal is triggered directly in the call management interface (that is, the call management process), as shown in FIG. 1a, which shows an exemplary interface after the voice-recording interface is triggered.

Practically, the call management interface can be closed first and then the voice-recording interface of the calling terminal is triggered in the embodiment of the disclosure.

In step 106, a voice input of the user is received, and audio data is generated.

In a case that the user wants to leave a voice message, voice is inputted via the voice-recording interface described above, and the calling terminal receives the voice input and then generates the audio data. As shown in FIG. 1a, the user presses on a bottom button, and then accesses an exemplary interface of a voice-recording process as shown in FIG. 1b to leave the message, the exemplary interface of the voice-recording process can display a process such as a voice-recording time length.

In the embodiment of the disclosure, since the audio data is transmitted via the Internet in step 108, a voice file format having smaller compression is selected to serve as a file format for generating the audio data, and the audio data can be stored in a memory card after a voice is recorded.

Preferably, after the voice is recorded, the embodiment further includes a process of determining whether to send the recorded voice. In a case that it is not desired to send the recorded voice, the recorded voice may be deleted, or in a case that the user determines to send the recorded voice, step 108 is entered. In a case that an operation that the user determines to send the recorded voice is received, step 108 is entered, as shown in FIG. 1c, which is an exemplary interface of waiting for the user to click to send the recorded voice.

In step 108, the audio data in the calling terminal is uploaded onto a server via the Internet Protocol, and the server provides the audio data to the called terminal for playing or downloading.

The audio data is uploaded onto the server via the Internet Protocol (such as the IP protocol) in step 108, as shown in FIG. 1d, which is an exemplary interface in which the audio data is sent to the server, as shown in FIG. 1e, which is an exemplary interface in which the audio data is sent by the calling terminal successfully. The server processes the audio data upon receiving the audio data, and then provides the audio data to the called terminal for playing or downloading.

In the embodiment, link information of the audio data processed by the server is sent to the called terminal. The called terminal can download the audio data from the server via the Internet to play in a case that a device (such as 360 safeguard) having a voice-playing function corresponding to the embodiment of the disclosure is installed in the called terminal, as shown in FIG. 1f, which is an exemplary interface in which the voice message is played by the 360 safeguard. The user can also open a corresponding web page via a browser based on the Internet according to the link information to play, as shown in FIG. 1g, which is an exemplary interface in which the voice message is played in a web page of the browser.

In the method for leaving a message according to the disclosure, after the user starts a call, the connection process made from the calling terminal to the called terminal is monitored, and whether the call is connected is determined. The voice-recording interface of the calling terminal is triggered in a case that the call is not connected, and a voice is recorded. The audio data is uploaded onto the server via the Internet protocol, and the server provides the audio data to the called terminal for playing or downloading, thereby solving problems that an operation of the user is cumbersome in a case that a short message or a multimedia message is used to leave a message and fees may be high, achieving beneficial effects of simplifying a operation process and reducing a possibility of high fees by performing data transmission via the Internet. In the embodiment of the disclosure, it is beneficial for the user to perform information interaction with a receiving part in time simply. In a case that the method for leaving a message according to the embodiment of the disclosure is not used, the user needs to perform cumbersome operation steps to send the voice message to the receiving part. However, in a case that the method for leaving a message according to the embodiment of the disclosure is used, only one step is required (in a case that the voice-sending acknowledge interface as shown in FIG. 1c is provided, only two steps are required) to send message information to the receiving part rapidly and conveniently.

### Second Embodiment

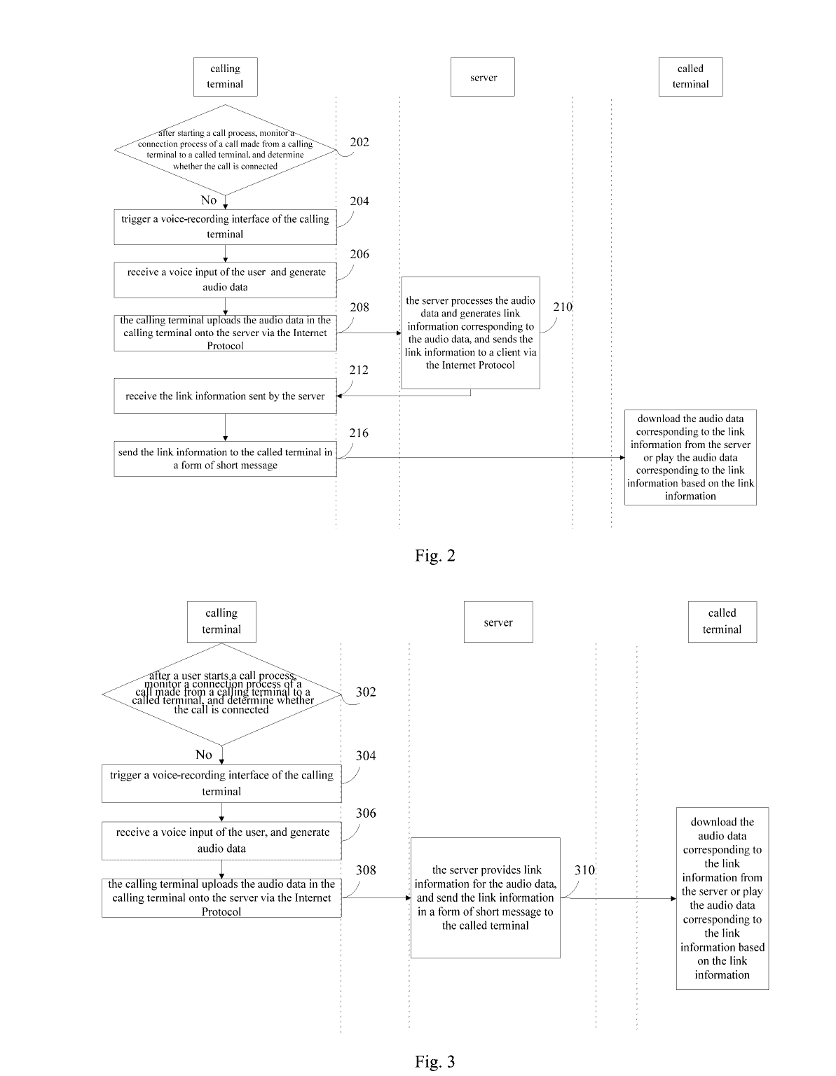

With reference to FIG. 2 which is a schematic flow diagram of a method for leaving a message according to the disclosure, the method for leaving the message includes step 202 to step 214.

In step 202, after a user starts a call process, a connection process of a call made from a calling terminal to a called terminal is monitored, and whether the call is connected is determined; and step 204 is entered in a case that the call is not connected.

In step 204, the voice-recording interface of the calling terminal is triggered in the calling terminal.

In step 206, the calling terminal receives a voice input of the user and generates audio data.

In step 208, the calling terminal uploads the audio data in the calling terminal onto a server via the Internet Protocol.

In step 210, the server processes the audio data and generates link information corresponding to the audio data, and return the link information to a client terminal via the Internet Protocol.

In step 212, the calling terminal receives the link information sent by the server.

In step 214, the calling terminal sends the link information to the called terminal in a form of short message.

In the embodiment of the disclosure, the server processes the audio data uploaded by the calling terminal, that is, the server stores the audio data and allocates the link information to the audio data, and returns the link information to the calling terminal via the Internet Protocol. The calling terminal sends the link information to the called terminal in the form of short message upon receiving the link information.

Preferably, a process of sending the link information to the called terminal in the form of short message includes step B10.

In step B10, the link information is sent to the called terminal in the form of short message by calling a short-message interface in a third-layer protocol of the GSM or the CDMA.

In a case that the user decides to send a voice message, the user uploads the voice message onto the server according to the Internet Protocol, and then the server returns link information to a sending teiniinal after processing the voice message. A client terminal sends the link information to a receiving terminal in the form of short message via the third-layer protocol of the GSM protocol or the CDMA2000 protocol (a connection management sub protocol layer in the third-layer protocol of the GSM, and the third-layer protocol referred to as an upper entity for the CDMA2000), and a window is closed after finishing sending the link information.

In the process described above, the calling terminal only sends the short link information to the called terminal, and the link information does not exceed a volume of a short message, thereby no extra fees are generated. Also, the short-message interface is called automatically to send the link information, thereby no operation of the user are increased.

The called terminal downloads the audio data corresponding to the audio data from the server or plays the audio data corresponding to the link information based on the link information upon receiving the short message. Furthermore, the called terminal further includes step 216.

In step 216, a received short message is monitored, and whether the short message is used for providing the link information of the audio data is determined; and the audio data is requested from the server based on the link information, and the audio data is played to the user, in a case that the short message is used for providing the link information of the audio data.

In the disclosure, a device having a voice-playing function can be installed in the called terminal. In the disclosure, the received short message is monitored, and whether the short message is used for providing the link information of the audio data is determined, and whether the device having the voice-playing function described above is installed in the system is determined. The audio data is requested from the server based on the link information, and the audio data is played to the user in the device, in a case that the short message is used for providing the voice message and the device having the voice-playing function described above is installed in the system. In practice, the user can be prompted whether to play the audio data before playing the audio data, and the audio data is played in a case that the user determines to play the audio data.

Preferably, the called terminal further includes step B12.

In step B12, in a case that at least two short messages for providing link information of the audio data are received, a popup is triggered to remind the user.

In a case that multiple short messages for providing link information of the audio data are received by the called terminal, a popup window is triggered by the called terminal to remind the user.

Alternatively, the called terminal further includes step 218.

In step 218, the user starts a browser to open a web page to play the audio data by clicking on the link information by the user in a case that a short message for providing the link information of the audio data is received.

In practice, in a case that the called terminal does not install the device having the voice-playing function, and the audio data cannot be downloaded directly to play in the disclosure, the user can open the short message and click on the link information, to start the browser to open a web page corresponding to the link information to play the audio data.

In the embodiment of the disclosure, the client terminal sends the link information returned by the server to the called terminal automatically, the called terminal downloads the audio data to play the audio data or opens the web page to play the audio data via the Internet upon receiving the short message. In this case, the calling terminal does not need to send the voice message to the called terminal in a form of multimedia message, thereby no extra fees are generated as long as the cell phone is located in an environment of wifi network or is within a range of a GPRS traffic limit thereof and the operation is simplified.

Principles of steps in the embodiment similar to the steps in the first embodiment are similar, which is not described in detail anymore.

### Third Embodiment

With reference to FIG. 3, which is a schematic flow diagram of a method for leaving a message according to the disclosure, the method for leaving the message includes step 302 to step 310.

In step 302, after a user starts a call process, a connection process of a call made from a calling terminal to a called terminal is monitored, and whether the call is connected is determined; and step 304 is entered in a case that the call is not connected.

In step 304, a voice-recording interface of the calling terminal is triggered in the calling terminal.

In step 306, the calling terminal receives a voice input of the user and generates audio data.

In step 308, the calling terminal uploads the audio data in the calling terminal onto a server via the Internet Protocol.

In step 310, the server provides link information for the audio data, and sends the link information to the called terminal in a form of short message.

In the embodiment of the disclosure, the server can send the link information to the called terminal. The called terminal downloads the audio data corresponding to the link information from the server or plays the audio data corresponding to the link information based on the link information.

Preferably, the process of uploading the audio data in the calling terminal onto a server via the Internet Protocol includes step C10.

In step C10, identity information of the calling terminal is uploaded onto the server.

In the embodiment of the disclosure, in order to prompt the called terminal with which sends a short message received by the called terminal in a case that the short message is sent to the called terminal from the server, the identity information of the calling terminal needs to be uploaded onto the server. Specifically, the identity information of the calling terminal includes identity information such as a phone number.

Furthermore, the process of sending the link information to the called terminal in the form of short message includes C12.

In C12, the called terminal is prompted with the identity information of the calling terminal corresponding to the link information.

The identity information of the calling terminal is put into the short message when the server sends the short message to the called terminal, to prompt the called terminal with the identity information of the calling terminal corresponding to the link information.

In the embodiment of the disclosure, the short message including the link information is sent to the called terminal by the server, thereby resource occupation of the called terminal is reduced.

The embodiment is similar to the first embodiment and the second embodiment, which is not described in detail anymore.

### Fourth Embodiment

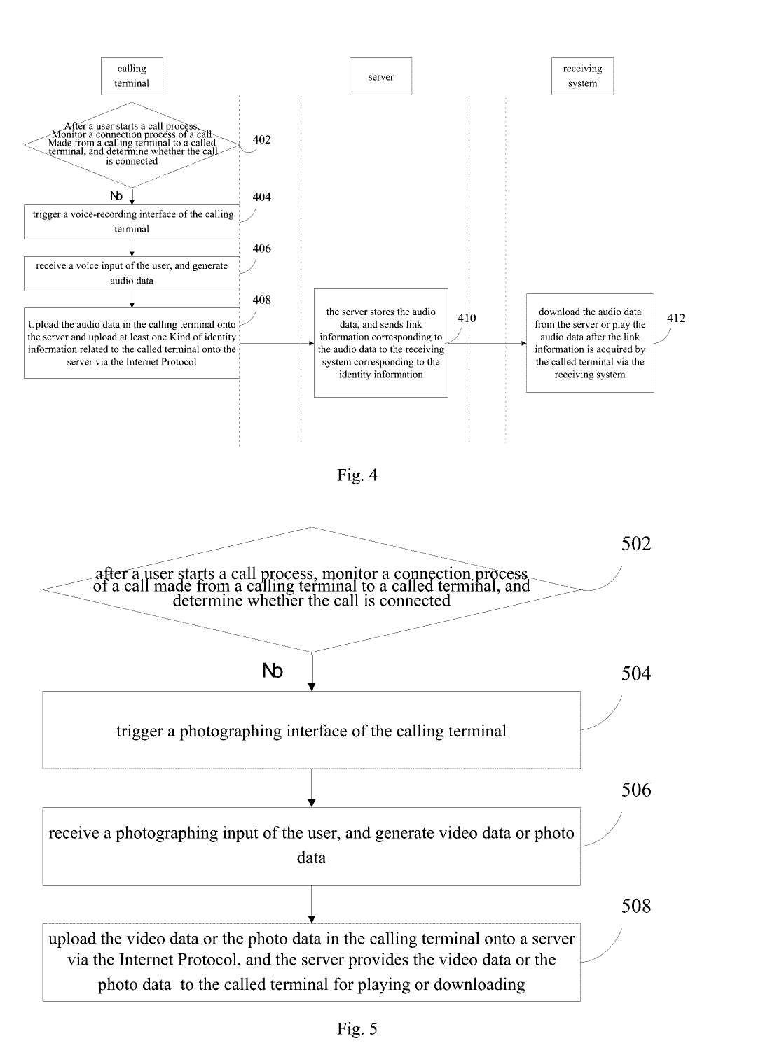

With reference to FIG. 4, which is a schematic flow diagram of a method for leaving a message according to the disclosure, the method for leaving the message includes step 402 to step 412.

In step 402, after a user starts a call process in a calling terminal, a connection process of a call made from the calling terminal to a called terminal is monitored, and whether the call is connected is determined; and step 404 is entered in a case that the call is not connected.

In step 404, a voice-recording interface of the calling terminal is triggered in the calling terminal.

In step 406, the calling terminal receives a voice input of the user and generates audio data.

In step 408, the calling terminal uploads the audio data in the calling terminal and at least one kind of identity information related to the called terminal onto a server via the Internet Protocol.

In the embodiment of the disclosure, multiple identity information corresponds to the called terminal, and different identity information may correspond to different receiving systems.

In the embodiment of the disclosure, the identity information of the called terminal includes a physical address and/or a network address related to the called terminal. The physical address includes a phone number, an IP (Internet Protocol) address, a mac (physical) address of the called terminal. The network address includes an email account and an instant messaging account of the called terminal.

Therefore, a receiving system corresponding to the physical address is the called terminal, and receiving systems corresponding to the network address such as the email account and the instant messaging account are an email system and an instant messaging system (such as MSN), respectively.

In step 410, the server stores the audio data, and sends link information of the audio data to a receiving system corresponding to the identity information.

Multiple receiving systems can be used in the embodiment of the disclosure. The link information is sent to the receiving system corresponding to the identity information of the called terminal.

In a case that the calling terminal uploads an email account used by a user of the called terminal onto the server in the disclosure, the server in the disclosure will sends a mail to the email account of the called terminal by calling an email interface. The mail includes the link information.

In a case that the calling terminal uploads an instant messaging account used by a user of the called terminal onto the server in the disclosure, the server in the disclosure sends information to the instant messaging account of the called terminal by calling an interface of an instant messaging system. The information includes the link information.

Other cases are similar.

In step 412, the called terminal will play the audio data or download the audio data from the server after acquiring the link information via the receiving system.

The called terminal can acquire the link information by checking the receiving system such as the email account or the instant messaging account, and then play the audio data or download the audio data from the server based on the link information. For example, the called terminal can directly open a web page in a browser to play the audio data.

In a case that the receiving system can be accessed not by the called terminal, the user can not be limited to acquire the link information from the called terminal. For example, in a case that a receiving system such as an email account or an instant messaging account can be logged from a PC or other terminal, the link information can be checked and acquired from the PC or other terminal which can be connected with the Internet.

The process of uploading the audio data in the calling terminal onto the server via the Internet Protocol includes step D10.

In step D10, identity information of the calling terminal is uploaded onto the server.

In the embodiment of the disclosure, in order to prompt the called terminal with which sends a short message received by the called terminal in a case that the short message is sent to the called terminal from the server, the identity information of the calling terminal needs to be uploaded onto the server. Specifically, the identity information of the calling terminal includes identity information such as a phone number.

Furthermore, the process of sending the link information of the audio data to the receiving system corresponding to the identity information includes:

prompting the called terminal or the receiving system with the identity information of the calling terminal corresponding to the link information.

The identity information of the calling terminal is put into the short message when the server pushes the link information to the receiving system of the called terminal, to prompt the called terminal with the identity information of the calling terminal corresponding to the link information.

In the embodiment of the disclosure, the audio data sent by the calling terminal is pushed onto different receiving systems of the called terminal via the server, thereby operations of the calling terminal is simplified and senseless fees are avoided.

Principles of steps in the embodiment similar to the steps in the first embodiment, the second embodiment and the third embodiment are similar, which is not described in detail anymore.

### Fifth Embodiment

With reference to FIG. 5, which is a schematic flow diagram of a method for leaving a message according to the disclosure, the method for leaving the message includes step 502 to step 508.

In step 502, after a user starts a call process, a connection process of a call made from a calling terminal to a called terminal is monitored, and whether the call is connected is determined; and step 504 is entered in a case that the call is not connected.

In the embodiment of the disclosure, in a case that the user of the calling terminal makes a call, the connection process of the call from the calling terminal can be monitored, and whether the call is connected is determined, the monitoring the connection process is ended in a case that the call is connected. A shortcut message-leaving function provided in the disclosure is triggered in a case that the call is not connected.

In practice, in the embodiment of the disclosure, it is regarded that the call is not connected in a case that a user of the called terminal hangs up initiatively, then step 504 is entered. Also, it is regarded that the call is not connected in a case that the user of the calling terminal hangs up initiatively. In this case, whether a time length of the connection process exceeds a threshold is determined, and step 504 is entered in a case that the time length exceeds the threshold.

Preferably, step 502 that after a user starts a call process, a connection process of a call made from a calling terminal to a called terminal is monitored, and whether the call is connected is determined includes step A10.

In step A10, a phone management API of a system is called to monitor a voice service in a connection management sub layer of the GSM protocol or in an upper entity of the CDMA, and whether the call is connected is determined.

In the embodiment of the disclosure, a conventional phone communication is monitored, that is, a call function of the cell phone is monitored. For example, in an android system, a phone management API provided by the android system is called to monitor a voice service in a connection management sub layer of the GSM protocol or in an upper entity of the CDMA 2000. In a case that it is learned that a call is dialed and then hanged up, a time length from dialing the call to hanging up the call is recorded in the voice service in the connection management sub layer or in the upper entity of the CDMA 2000 described above, a call record database of the system is queried, to check whether a value in an answering field of the call in the database represents that the call is connected. In a case that the call is not connected and the user waits for a time length greater than 15 s, the user is prompted to leave a message, and step 504 is triggered.

Alternatively, in an iOS system, similarly, a phone management API provided by the iOS system is called to monitor a voice service in a connection management sub layer of the GSM protocol or in an upper entity of the CDMA 2000, the phone management API of the iOS system can monitor whether the call is connected, therefore, processing in the iOS system is simpler compared with the android system, which only needs that the API is used to monitor a process from dialing the call to hanging up the call and if the call is not connected, the user is prompted to leave a message in a case that a time length of the process exceeds 15 s.

Preferably, in a case that the call is not connected, step 502 further includes step A52.

In step A52, call duration for the call which is not connected is acquired, and it is determined whether the call duration exceeds a threshold, step 504 is entered in a case that the duration exceeds the threshold.

For example, in a case that the threshold is 15 s described above, and a photographing interface of the calling terminal is not triggered in a case that the call duration does not exceed 15 s. Step 504 is entered in a case that the call duration exceeds 15 s.

In step 504, the photographing interface of the calling terminal is triggered.

After it is determined in steps described above that the call made by the calling terminal is not connected (further it is determined whether the time length from dialing the call to hanging up the call exceeds the threshold), the photographing interface of the calling terminal is triggered.

In the embodiment of the disclosure, in a case that the user uses a terminal such as a cell phone to make a call, a call management interface for making a call is accessed, that is, the calling terminal performs a call-dialing action in a call management process. In a case that it is monitored that the call dialed by the user is not connected, the photographing interface of the calling terminal is triggered directly in the call management interface (that is, the call management process).

Practically, the call management interface can be closed first and then the photographing interface of the calling terminal is triggered in the embodiment of the disclosure.

In step 506, a photographing input of the user is received, and video data or photo data is generated.

In a case that the user wants to leave a video message or a photo message, the photographing interface described above is used to photograph a video or take a photo, and the calling terminal receives the video or the photo, and then generates the video data or the photo data. Preferably, after the photographing is finished, the embodiment further includes a process of determining whether to send photographed video or taken photo. In a case that it is not desired to send the photographed video or the photo, the video and photo are deleted, or in a case that the user determines to send the photographed video or the photo, step 508 is entered.

In step 508, the video data or the photo data in the calling terminal is uploaded onto a server via the Internet Protocol, and the server provides the video data or the photo data to the called terminal for playing or downloading.

The video data or the photo data is uploaded onto the server via the Internet Protocol (such as the IP protocol) in step 508. The server processes the video data or the photo data upon receiving the video data or the photo data, and then provides the video data or the photo data to the called terminal for playing or downloading.

In the embodiment, link information of the video data or the photo data processed by the server is sent to the called terminal. The called terminal can download the video data or the photo data from the server via the Internet to play in a case of installing a device (such as 360 safeguard) having a video-playing function or a photo-playing function corresponding to the embodiment of the disclosure.

In the method for leaving a message according to the disclosure, after the user starts a call, the connection process made from the calling terminal to the called terminal is monitored, and whether the call is connected is determined. The photographing interface of the calling terminal is triggered to photograph in a case that the call is not connected. The video data or the photo data is uploaded onto the server via the Internet protocol, and the server provides the video data or the photo data to the called terminal for playing or downloading, thereby solving a problem of high fees since that an operation of the user is cumbersome in a case that a short message or a multimedia message is used to leave a message, achieving beneficial effects of simplifying a operation process and reducing a possibility of high fees by performing data transmission via the Internet. In the embodiment of the disclosure, it is beneficial for the user to perform information interaction with a receiving part in time simply. In a case that the method for leaving a message according to the embodiment of the disclosure is not used, the user needs to perform cumbersome operation steps to send the video information or the photo information to the receiving part. However, in a case that the method for leaving a message according to the embodiment of the disclosure is used, only one step is required (in a case that a information-sending function is provided, only two steps are required) to send message information to the receiving part rapidly and conveniently.

### Sixth Embodiment

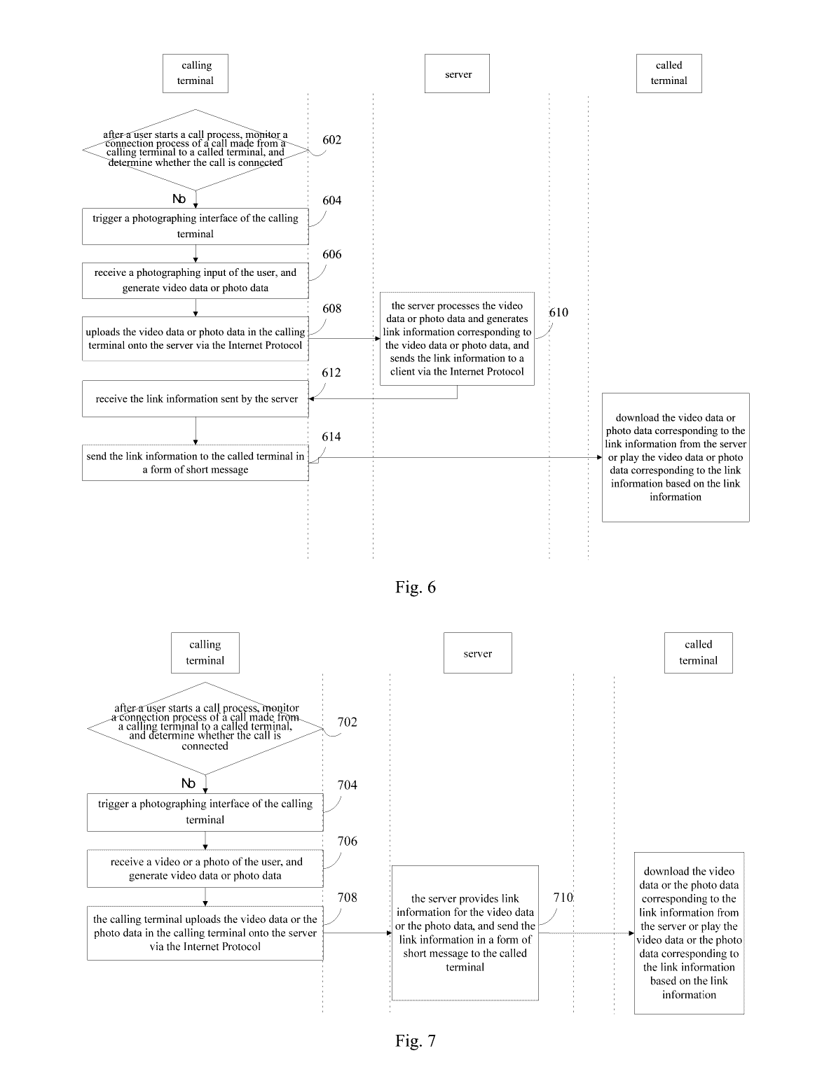

With reference to FIG. 6 which is a schematic flow diagram of a method for leaving a message according to the disclosure, the method for leaving the message includes step 602 to step 614.

In step 602, after a user starts a call process, a connection process of a call made from a calling terminal to a called terminal is monitored, and whether the call is connected is determined; and step 604 is entered in a case that the call is not connected.

In step 604, a photographing interface of the calling terminal is triggered in the calling terminal.

In step 606, the calling terminal receives a photographing input of the user and generates video data or photo data.

In step 608, the calling terminal uploads the video data or the photo data in the calling terminal onto a server via the Internet Protocol.

In step 610, the server processes the video data or the photo data and generates link information corresponding to the video data or the photo data, and return the link information to a client terminal via the Internet Protocol.

In step 612, the calling terminal receives the link information sent by the server.

In step 614, the calling terminal sends the link information to the called terminal in a form of short message.

In the embodiment of the disclosure, the server processes the video data or the photo data uploaded by the calling terminal, that is, the server stores the video data or the photo data and allocates the link information to the video data or the photo data, and returns the link information to the calling terminal via the Internet Protocol. The calling terminal sends the link information to the called terminal in the form of short message upon receiving the link information. The called terminal downloads the video data or the photo data corresponding to the link information from the server or plays the video data or the photo data corresponding to the link information based on the link information.

Preferably, a process of sending the link information to the called terminal in the form of short message includes step B60.

In step B60, the link information is sent to the called terminal in the form of short message by calling a short-message interface in a third-layer protocol of the GSM or the CDMA.

In a case that the user decides to send a video message or a photo message, the user uploads the video message or the photo message onto the server according to the Internet Protocol, and then the server returns link information to a sending terminal after processing the video message or the photo message. A client terminal sends the link information to a receiving terminal in the form of short message via the third-layer protocol of the GSM protocol or the CDMA2000 protocol (a connection management sub protocol layer in the third-layer protocol for the GSM, and the third-layer protocol referred to as an upper entity for the CDMA2000), and a window is closed after finishing sending the link information.

In the process described above, the calling terminal only sends the short link information to the called terminal, and the link information does not exceed a volume of a short message, thereby no extra fees are generated. Also, the short-message interface is called automatically to send the link information, thereby no operation of the user are increased.

Furthermore, the called terminal further includes step 616.

In step 616, a received short message is monitored, and whether the short message is a used for providing the link information of the video data or the photo data is determined; and the video data or the photo data is requested from the server based on the link information, and the video data or the photo data is played to the user, in a case that the short message is used for providing the link information of the video data or the photo data.

In the disclosure, a device having a video-playing function or a photo-playing function can be installed in the called terminal. In the disclosure, the received short message is monitored, and whether the short message is used for providing the link information of the video data or the photo data is determined, and whether the device having the video-playing function or the photo-playing function described above is installed in the system is determined. The video data or the photo data is requested from the server based on the link information, and the video data or the photo data is played to the user in the device, in a case that the short message is used for providing the photographing message and the device having the video-playing function or the photo-playing function described above is installed in the system. In practice, the user can be prompted whether to play the video data or the photo data before playing the video data or the photo data, and the video data or the photo data is played in a case that the user determines to play the video data or the photo data.

Preferably, the called terminal further includes step B62.

In step B12, in a case that at least two short messages for providing link information of the video data or the photo data are received, a popup window is triggered to remind the user.

In a case that multiple short messages for providing link information of the video data or the photo data are received by the called terminal, a popup is triggered by the called terminal to remind the user.

Alternatively, the called terminal further includes step 618.

In step 618, the user starts a browser to open a web page to play the video data or the photo data by clicking on the link information by the user in a case that a short message for providing the link information of the video data or the photo data is received.

In practice, in a case that the called terminal does not install the device having the video-playing function or the photo-playing function, and the video data or the photo data cannot be downloaded directly to play in the disclosure, the user can open the short message and click on the link information, to start the browser to open a web page corresponding to the link information to play the video data or the photo data.

In the embodiment of the disclosure, the client terminal sends the link information returned by the server to the called terminal automatically, the called terminal downloads the video data or the photo data or opens the web page to play the video data or the photo data via the Internet upon receiving the short message. In this case, the calling terminal does not send the video message or the photo message to the called terminal in a form of multimedia message, thereby no extra fees are generated as long as the cell phone is located in an environment of wifi network or is within a range of a GPRS traffic limit thereof and the operation is simplified.

Principles of steps in the embodiment similar to the steps in the fifth embodiment are similar, which is not described in detail anymore.

### Seventh Embodiment

With reference to FIG. 7, which is a schematic flow diagram of a method for leaving a message according to the disclosure, the method for leaving the message includes step 702 to step 710.

In step 702, after a user starts a call process, a connection process of a call made from a calling terminal to a called terminal is monitored, and whether the call is connected is determined; and step 704 is entered in a case that the call is not connected.

In step 704, a photographing interface of the calling terminal is triggered in the calling terminal.

In step 706, the calling terminal receives a video input or a photo input of the user and generates video data or photo data.

In step 708, the calling terminal uploads the video data or the photo data in the calling terminal onto a server via the Internet Protocol.

In step 710, the server provides link information for the video data or the photo data, and sends the link information to the called terminal in a form of short message.

In the embodiment of the disclosure, the server can send the link information to the called terminal. The called terminal downloads the video data or the photo data corresponding to the link information from the server or plays the video data or the photo data corresponding to the link information based on the link information.

Preferably, the process of uploading the video data or the photo data in the calling terminal onto a server via the Internet Protocol includes step C70.

In step C70, identity information of the calling terminal is uploaded onto the server.

In the embodiment of the disclosure, in order to prompt the called terminal with which sends a short message received by the called terminal in a case that the short message is sent to the called terminal from the server, the identity information of the calling terminal needs to be uploaded onto the server. Specifically, the identity information of the calling terminal includes identity information such as a phone number.

Furthermore, the process of sending the link information to the called terminal in the form of short message includes C72.

In C72, the called terminal is prompted with the identity information of the calling terminal corresponding to the link information.

The identity information of the calling terminal is put into the short message when the server sends the short message to the called terminal, to prompt the called terminal with the identity information of the calling terminal corresponding to the link information.

In the embodiment of the disclosure, the short message including the link information is sent to the called terminal by the server, thereby resource occupation of the called terminal is reduced.

The embodiment is similar to the fifth embodiment and the sixth embodiment, which is not described in detail anymore.

### Eighth Embodiment

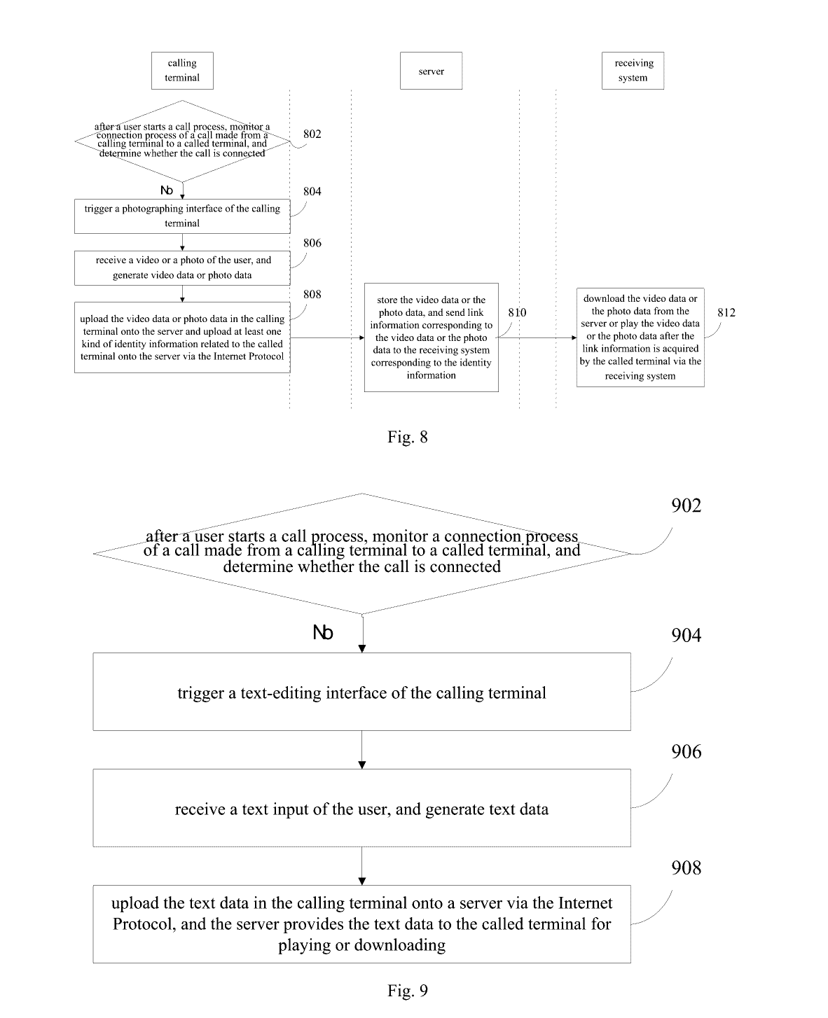

With reference to FIG. 8, which is a schematic flow diagram of a method for leaving a message according to the disclosure, the method for leaving the message includes step 802 to step 812.

In step 802, after a user starts a call process in a calling terminal, a connection process of a call made from the calling terminal to a called terminal is monitored, and whether the call is connected is determined; and step 804 is entered in a case that the call is not connected.

In step 804, a photographing interface of the calling terminal is triggered in the calling terminal.

In step 806, the calling terminal receives a video input or a photo input of the user and generates video data or photo data.

In step 808, the calling terminal uploads the video data or the photo data in the calling terminal and at least one kind of identity information related to the called terminal onto a server via the Internet Protocol.

In the embodiment of the disclosure, multiple identity information corresponds to the called terminal, and different identity information may correspond to different receiving systems.

In the embodiment of the disclosure, the identity information of the called terminal includes a physical address and/or a network address related to the called terminal. The physical address includes a phone number, an IP address (Internet Protocol Address) and an mac (Media Access Control Address) address of the called terminal. The network address includes an email account and an instant messaging account of the called terminal.

Therefore, a receiving system corresponding to the physical address is the called terminal, and receiving systems corresponding to the network address such as the email account and the instant messaging account are an email system or an instant messaging system (such as MSN), respectively.

In step 810, the server stores the video data or the photo data, and sends link information of the video data or the photo data to a receiving system corresponding to the identity information.

Multiple receiving systems can be used in the embodiment of the disclosure. The link information is sent to the receiving system corresponding to the identity information of the called terminal.

In a case that the calling terminal uploads an email account used by a user of the called terminal onto the server in the disclosure, the server in the disclosure will sends a mail to the email account of the called terminal by calling an email interface. The mail includes the link information.

In a case that the calling terminal uploads an instant messaging account used by a user of the called terminal onto the server in the disclosure, the server in the disclosure sends information to the instant messaging account of the called terminal by calling an interface of an instant messaging system. The information includes the link information.

Other cases are similar.

In step 812, the called terminal will play the video data or the photo data from the server or download the video data or the photo data after acquiring the link information via the receiving system.

The called terminal can acquire the link information by checking the receiving system such as the email account or the instant messaging account, and then play the video data or the photo data or download the video data or the photo data from the server based on the link information. For example, the called terminal can directly open a web page in a browser to play the video data or the photo data.

The process of uploading the video data or the photo data in the calling terminal onto the server via the Internet Protocol includes step D80.

In step D80, identity information of the calling terminal is uploaded onto the server.

In the embodiment of the disclosure, in order to prompt the called terminal with which sends a short message received by the called terminal in a case that the short message is sent to the called terminal from the server, the identity information of the calling tetininal needs to be uploaded onto the server. Specifically, the identity information of the calling terminal includes identity information such as a phone number.

Furthermore, the process of sending the link information of the video data or the photo data to the receiving system corresponding to the identity information includes:

prompting the called terminal or the receiving system with the identity information of the calling terminal corresponding to the link information.

The identity information of the calling terminal is put into the short message when the server pushes the link information to the receiving system of the called terminal, to prompt the called terminal with the identity information of the calling terminal corresponding to the link information.

In the embodiment of the disclosure, the video data or the photo data sent by the calling terminal is pushed onto different receiving systems of the called terminal via the server, thereby an operation of the calling terminal are simplified and senseless fees are avoided.

Principles of steps in the embodiment similar to the steps in the fifth embodiment, the sixth embodiment and the seventh embodiment are similar, which is not described in detail anymore.

### Ninth Embodiment

With reference to FIG. 9, which is a schematic flow diagram of a method for leaving a message according to the disclosure, the method for leaving the message includes step 902 to step 908.

In step 902, after a user starts a call process, a connection process of a call made from a calling terminal to a called terminal is monitored, and whether the call is connected is determined; and step 904 is entered in a case that the call is not connected.

In the embodiment of the disclosure, in a case that the user of the calling terminal makes a call, the connection process of the call from the calling terminal can be monitored, and whether the call is connected is determined, the monitoring the connection process is ended in a case that the call is connected. A shortcut message-leaving function provided in the disclosure is triggered in a case that the call is not connected.

In practice, in the embodiment of the disclosure, it is regarded that the call is not connected in a case that a user of the called terminal hangs up initiatively, then step 904 is entered. Also, it is regarded that the call is not connected in a case that the user of the calling terminal hangs up initiatively. In this case, whether a time length of the connection process exceeds a threshold is determined, and step 904 is entered in a case that the time length exceeds the threshold.

Preferably, step 902 that after a user starts a call process, a connection process of a call made from a calling terminal to a called terminal is monitored, and whether the call is connected is determined includes step A90.

In step A90, a phone management API of a system is called to monitor a voice service in a connection management sub layer of the GSM protocol or in an upper entity of the CDMA, and whether the call is connected is determined.

In the embodiment of the disclosure, a conventional phone communication is monitored, that is, a call function of the cell phone is monitored. For example, in an android system, a phone management API provided by the android system is called to monitor a voice service in a connection management sub layer of the GSM protocol or in an upper entity of the CDMA 2000. In a case that it is learned that a call is dialed and then hanged up, a time length from dialing the call to hanging up the call is recorded in the voice service in the connection management sub layer or in the upper entity of the CDMA 2000 described above, a call record database of the system is queried, to check whether a value in an answering field of the call in the database represents that the call is connected. In a case that the call is not connected and the user waits for a time length greater than 15 s, the user is prompted to leave a message, and step 904 is triggered.

Alternatively, in an iOS system, similarly, a phone management API provided by the iOS system is called to monitor a voice service in a connection management sub layer of the GSM protocol or in an upper entity of the CDMA 2000, the phone management API of the iOS system can monitor whether the call is connected, therefore, processing in the iOS system is simpler compared with the android system, which only needs that the API is used to monitor a process from dialing the call to hanging up the call and if the call is not connected, and the user is prompted to leave a message in a case that a time length of the process exceeds 15 s.

Preferably, in a case that the call is not connected, step 902 further includes step A52.

In step A52, a call duration for the call which is not connected is acquired, and it is determined whether the call duration exceeds a threshold, step 904 is entered in a case that the duration exceeds the threshold.

For example, in a case that the threshold is 15 s described above, and a text-editing interface of the calling terminal is not triggered in a case that the call duration does not exceed 15 s. Step 904 is entered in a case that the call duration exceeds 15 s.

In step 904, the text-editing interface of the calling terminal is triggered.

After it is determined in steps described above that the call made by the calling terminal is not connected (further it is determined whether the time length from making the call to hanging up the call exceeds the threshold), the text-editing interface of the calling terminal is triggered.

In the embodiment of the disclosure, in a case that the user uses a terminal such as a cell phone to make a call, a call management interface for making a call is accessed, that is, the calling terminal performs a call-dialing action in a call management process. In a case that it is monitored that the call dialed by the user is not connected, the text-editing interface of the calling terminal is triggered directly in the call management interface (that is, the call management process).

Practically, the call management interface can be closed first and then the text-editing interface of the calling terminal is triggered in the embodiment of the disclosure.

In step 906, a text input of the user is received, and text data is generated.

In a case that the user wants to leave a text message or a photo message, text is inputted via the text-editing interface described above, and the calling terminal receives the text input, and then generates the text data. Preferably, after the text input is finished, the embodiment further includes a process of determining whether to send the text data. In a case that the user does not desire to send the text data, the text data is deleted, or in a case that the user determines to send the text data, step 908 is entered.

In step 908, the text data in the calling terminal is uploaded onto a server via the Internet Protocol, and the server provides the text data to the called terminal for playing or downloading.

The text data is uploaded onto the server via the Internet Protocol (such as the IP protocol) in step 908. The server processes the text data upon receiving the text data, and then provides the text data to the called terminal for playing or downloading.

In the embodiment of the disclosure, link information of the text data processed by the server is sent to the called terminal. The called terminal can download the text data from the server via the Internet to play in a case of installing a device (such as 360 safeguard) having a text-playing function corresponding to the embodiment of the disclosure.

In the method for leaving a message according to the disclosure, after the user starts a call, the connection process made from the calling terminal to the called terminal is monitored, and whether the call is connected is determined. The text-editing interface of the calling terminal is triggered to text data in a case that the call is not connected. The text data is uploaded onto the server via the Internet protocol, and the server provides the text data to the called terminal for playing or downloading, thereby solving a problem of high fees since that an operation of the user is cumbersome in a case that a short message or a multimedia message is used to leave a message, achieving beneficial effects of simplifying a operation process and reducing a possibility of high fees by performing data transmission via the Internet. In the embodiment of the disclosure, it is beneficial for the user to perform information interaction with a receiving part in time simply. In a case that the method for leaving a message according to the embodiment of the disclosure is not used, the user performs cumbersome operation steps to send the text information to the receiving part. However, in a case that the method for leaving a message according to the embodiment of the disclosure is used, only one step is required (in a case that a information-sending function is provided, only two steps are required) to send message information to the receiving part rapidly and conveniently.

### Tenth Embodiment

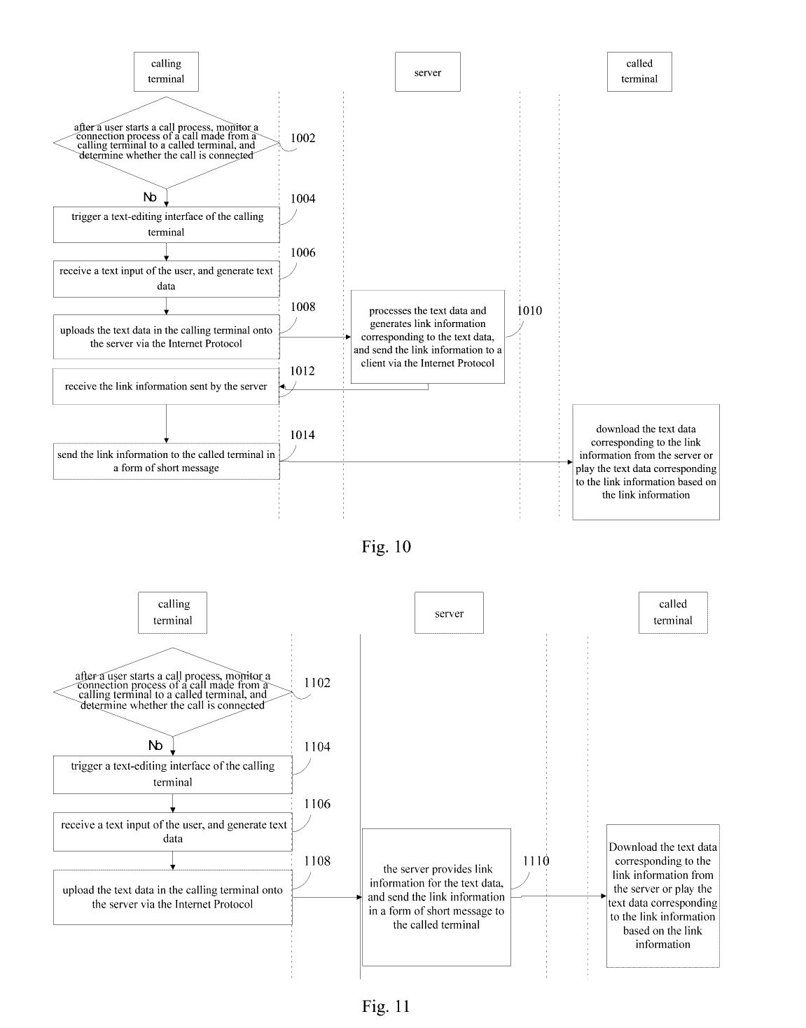

With reference to FIG. 10 which is a schematic flow diagram of a method for leaving a message according to the disclosure, the method for leaving the message includes step 1002 to step 1014.

In step 1002, after a user starts a call process, a connection process of a call made from a calling terminal to a called terminal is monitored, and whether the call is connected is deteimined; and step 1004 is entered in a case that the call is not connected.

In step 1004, a text-editing interface of the calling terminal is triggered in the calling terminal.

In step 1006, the calling terminal receives a text input of the user and generates text data.

In step 1008, the calling terminal uploads the text data in the calling terminal onto a server via the Internet Protocol.

In step 1010, the server processes the text data and generates link information corresponding to the text data, and return the link information to a client terminal via the Internet Protocol.

In step 1012, the calling terminal receives the link information sent by the server.

In step 1014, the calling terminal sends the link information to the called teiminal in a form of short message.

In the embodiment of the disclosure, the server processes the text data uploaded by the calling terminal, that is, the server stores the text data and allocates the link information to the text data, and returns the link information to the calling terminal via the Internet Protocol. The calling terminal sends the link information to the called terminal in the form of short message upon receiving the link information.

Preferably, a process of sending the link information to the called terminal in the form of short message includes step B1060.

In step B1060, the link information is sent to the called terminal in the form of short message by calling a short-message interface in a third-layer protocol of the GSM or the CDMA.

In a case that the user decides to send a text message, the user uploads the text message onto the server according to the Internet Protocol, and then the server returns link information to a sending terminal after processing the text message. A client terminal sends the link information to a receiving terminal in the form of short message via the third-layer protocol of the GSM protocol or the CDMA2000 protocol (a connection management sub protocol layer in the third-layer protocol for the GSM, and the third-layer protocol referred to as an upper entity for the CDMA2000), a window is closed after finishing sending the link information.

In the process described above, the calling terminal only sends the short link information to the called terminal, and the link information does not exceed a volume of a short message, thereby no generating extra fees. Also, the short-message interface is called automatically to send the link information, thereby no operation of the user is increased.

Furthermore, the called terminal further includes step 1016.

In step 1016, a received short message is monitored, and whether the short message is a used for providing the link information of the text data is determined; and the text data is requested from the server based on the link information, and the text data is played to the user, in a case that the short message is used for providing the link information of the text data.

In the disclosure, a playing device can be installed in the called terminal. In the disclosure, the received short message is monitored, and whether the short message is the short message for providing the link information of the text data is determined, and whether the playing device described above is installed in the system is determined. The text data is requested from the server based on the link information, and the text data is played to the user in the playing device, in a case that the short message is the short message for providing the link information of the text data and the playing device described above is installed in the system. In practice, the user can be prompted whether to play text data before playing the text data, and the text data is played in a case that the user determines to play the text data.

Preferably, the called terminal further includes step B1062.

In step B62, in a case that at least two short messages for providing link information of the text data are received, a popup is triggered to remind the user.

In a case that multiple short messages for providing link information of the text data are received by the called terminal, a popup is triggered by the called terminal to remind the user.

Alternatively, the called terminal further includes step 1018.

In step 1018, the user starts a browser to open a web page to play the text data by clicking on the link information by the user in a case that a short message for providing the link information of the audio data is received.

In practice, in a case that the called terminal does not install the playing device, and the text data can not be downloaded directly to play in the disclosure, the user can open the short message and click on the link information, to start the browser to open a web page corresponding to the link information to play the text data.

In the embodiment of the disclosure, the client terminal sends the link information returned by the server to the called terminal automatically, the called terminal downloads the text data to play or opens the web page to play the text data via the Internet upon receiving the short message. Extra fees is not generated as long as the cell phone is located in an environment of wifi network or is within a range of a GPRS traffic limit thereof, and the operation is simplified.

Principles of steps in the embodiment similar to the steps in the ninth embodiment are similar, which is not described in detail anymore.

### Eleventh Embodiment

With reference to FIG. 11, which is a schematic flow diagram of a method for leaving a message according to the disclosure, the method for leaving the message includes step 1102 to step 1110.

In step 1102, after a user starts a call process, a connection process of a call made from a calling terminal to a called terminal is monitored, and whether the call is connected is determined; and step 1104 is entered in a case that the call is not connected.

In step 1104, a text-editing interface of the calling terminal is triggered in the calling terminal.

In step 1106, the calling terminal receives a text input of the user and generates text data.

In step 1108, the calling terminal uploads the text data in the calling terminal onto a server via the Internet Protocol.

In step 1110, the server provides link information for the text data, and sends the link information to the called terminal in a form of short message.

In the embodiment of the disclosure, the server sends the link information to the called terminal. The called terminal downloads the text data corresponding to the link information from the server or plays the text data corresponding to the link information based on the link information.

Preferably, the process of uploading the text data in the calling terminal onto a server via the Internet Protocol includes step C1170.

In step C1170, identity information of the calling terminal is uploaded onto the server.

In the embodiment of the disclosure, in order to prompt the called terminal with which sends a short message received by the called terminal in a case that the short message is sent to the called terminal from the server, the identity information of the calling terminal is uploaded onto the server. Specifically, the identity information of the calling terminal includes identity information such as a phone number.

Furthermore, the process of sending the link information to the called terminal in the form of short message includes C1172.

In C1172, the called terminal is prompted with the identity information of the calling terminal corresponding to the link information.

The identity information of the calling terminal is put into the short message when sending the short message to the called terminal by the server, to prompt the called terminal with the identity information of the calling terminal corresponding to the link information.

In the embodiment of the disclosure, the short message including the link information is sent to the called terminal by the server, thereby reducing resource occupation of the called terminal.

The embodiment is similar to the ninth embodiment and the eighth embodiment, which is not described in detail anymore.

### Twelfth Embodiment

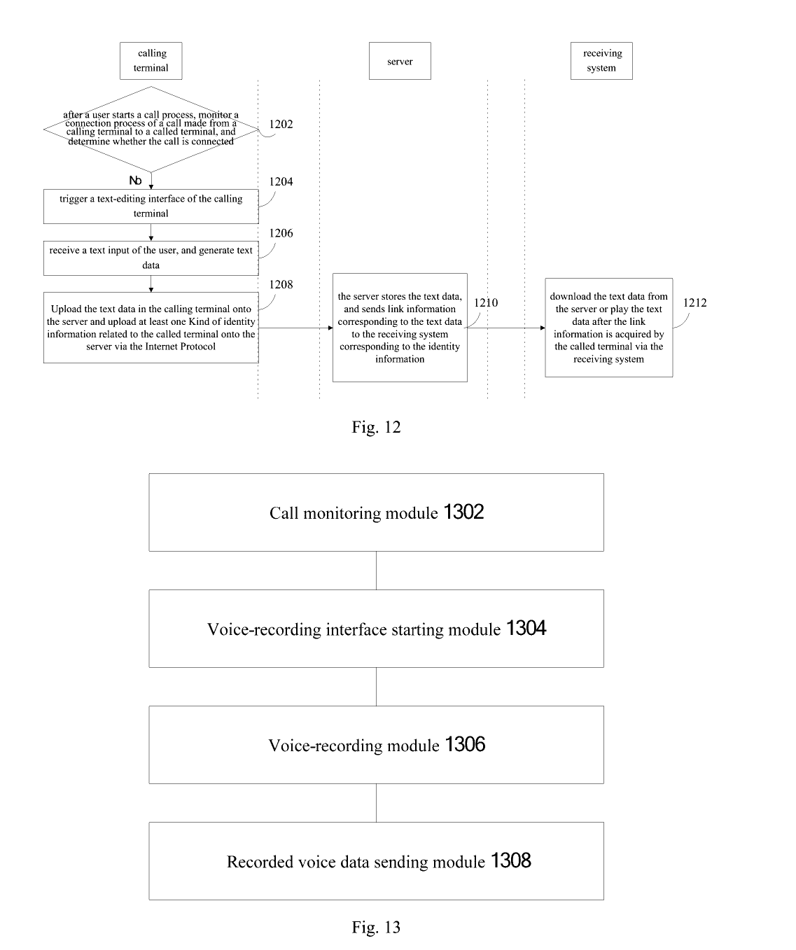

With reference to FIG. 12, which is a schematic flow diagram of a method for leaving a message according to the disclosure, the method for leaving the message includes step 1202 to step 1212.

In step 1202, after a user starts a call process in a calling terminal, a connection process of a call made from the calling terminal to a called terminal is monitored, and whether the call is connected is determined; and step 1204 is entered in a case that the call is not connected.

In step 1204, a text-editing interface of the calling terminal is triggered in the calling terminal.

In step 1206, the calling terminal receives a text input of the user and generates text data.

In step 1208, the calling terminal uploads the text data in the calling terminal and at least one kind of identity information related to the called terminal onto a server via the Internet Protocol.

In the embodiment of the disclosure, multiple identity information corresponds to the called terminal, and different identity information may correspond to different receiving systems.

In the embodiment of the disclosure, the identity information of the called terminal includes a physical address and/or a network address related to the called terminal. The physical address includes a phone number, an IP address or an mac address of the called terminal. The network address includes an email account or an instant messaging account of the called terminal.

Therefore, a receiving system corresponding to the physical address is the called terminal, and receiving systems corresponding to the network address such as the email account and the instant messaging account are an email system or an instant messaging system (such as MSN), respectively.

In step 1210, the server stores the text data, and sends link information of the text data to a receiving system corresponding to the identity information.

Multiple receiving systems can be used in the embodiment of the disclosure. The link information is sent to the receiving system corresponding to the identity information of the called terminal.

In a case that the calling terminal uploads an email account used by a user of the called terminal onto the server in the disclosure, the server in the disclosure will sends a mail to the email account of the called terminal by calling an email interface. The mail includes the link information.

In a case that the calling terminal uploads an instant messaging account used by a user of the called terminal onto the server in the disclosure, the server in the disclosure sends information to the instant messaging account of the called terminal by calling an interface of an instant messaging system. The information includes the link information.

Other cases are similar.

In step 1212, the called terminal will play the text data or download the text data from the server after acquiring the link information via the receiving system.

The called terminal can acquire the link information by checking the receiving system such as the email account or the instant messaging account, and then play the text data or download the text data from the server based on the link information. For example, the called terminal can directly open a web page in a browser to play the text data.

The process of uploading the text data in the calling terminal onto the server via the Internet Protocol includes step D1280.

In step D1280, identity information of the calling terminal is uploaded onto the server.

In the embodiment of the disclosure, in order to prompt the called terminal with which sends a short message received by the called terminal in a case that the short message is sent to the called terminal from the server, the identity information of the calling terminal is uploaded onto the server. Specifically, the identity information of the calling terminal includes identity information such as a phone number.

Furthermore, the process of sending the link information of the text data to the receiving system corresponding to the identity information includes:

prompting the called terminal or the receiving system with the identity information of the calling terminal corresponding to the link information.

The identity information of the calling terminal is put into the short message when the server pushes the link information to the receiving system of the called terminal, to prompt the called terminal with the identity information of the calling terminal corresponding to the link information.

In the embodiment of the disclosure, the text data sent by the calling terminal is pushed onto different receiving systems of the called terminal via the server, thereby simplifying an operation of the calling terminal and avoiding senseless fees.

Principles of steps in the embodiment similar to the steps in the ninth embodiment, the tenth embodiment and the eleventh embodiment are similar, which is not described in detail anymore.

### Thirteenth Embodiment

With reference to FIG. 13, which is a schematic structural diagram of a system for leaving a message according to the disclosure, the system for leaving the message includes a call monitoring module 1302, a voice-recording interface starting module 1304, a voice-recording module 1306 and a recorded voice data sending module 1308.

The call monitoring module 1302 is configured to, after a user starts a call process, monitor a connection process of a call made from a calling terminal to a called terminal, and determine whether the call is connected.

The voice-recording interface starting module 1304 is configured to trigger a voice-recording interface of the calling terminal in a case that the call is not connected.

The voice-recording module 1306 is configured to receive a voice input of the user and generate audio data.

The recorded data sending module 1308 is configured to upload the audio data in the calling terminal onto a server via the Internet Protocol, the server provides the audio data to the called terminal for playing or downloading.

The call monitoring module further includes a duration determining module.

The duration determining module is configured to acquire a call duration of the call which is not connected in a case that the call is not connected, determine whether the call duration of the call exceeds a threshold, and trigger the voice-recording interface of the calling terminal in a case that the call duration of the call exceeds the threshold.

The call monitoring module includes a first call monitoring module.

The first call monitoring module is configured to monitor a voice service in a connection management sub layer of the GSM protocol or in an upper entity of the CDMA by calling a phone management API of the of a system, and determine whether the call is connected.

### Fourteenth Embodiment

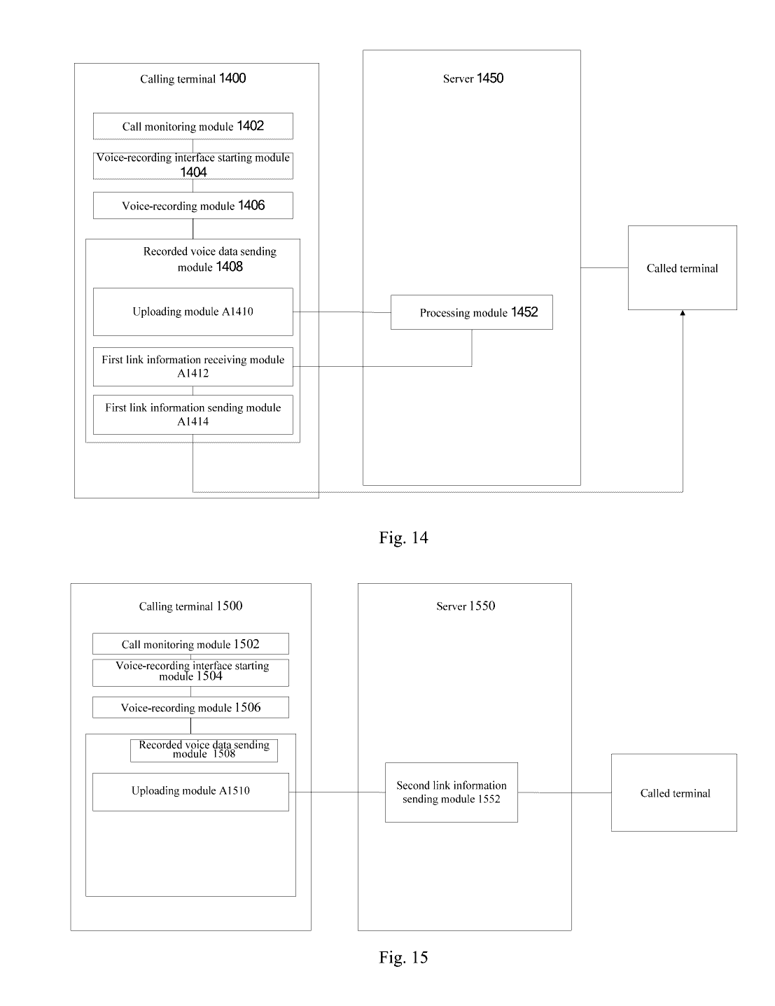

With reference to FIG. 14, which is a schematic structural diagram of a system for leaving a message according to the disclosure, the system for leaving the message includes a server 1450 and a calling terminal 1400. The calling terminal 1400 includes a call monitoring module 1402, a voice-recording interface starting module 1404, a voice-recording module 1406 and a recorded voice data sending module 1408.

The call monitoring module 1402 is configured to, after a user starts a call process, monitor a connection process of a call made from a calling terminal to a called terminal, and determine whether the call is connected.

The voice-recording interface starting module 1404 is configured to trigger a voice-recording interface of the calling terminal in a case that the call is not connected.

The voice-recording module 1406 is configured to receive a voice input of the user and generate audio data.

The recorded data sending module 1408 includes an uploading module A1410, a first link information receiving module A1412 and a first link information sending module A1414.

The uploading module A1410 is configured to upload the audio data in the calling terminal onto the server via the Internet Protocol.

The first link information receiving module A1412 is configured to receive link information sent by the server.

The first link information sending module A1414 is configured to send the link information to the called terminal in a form of short message.

The server 1450 includes a processing module 1452.

The processing module 1452 is configured to process the audio data, generate link information corresponding to the audio data, and return the link information to a client via the Internet Protocol.

Preferably, the recorded voice data sending module includes an identity information uploading module.

The identity information uploading module is configured to upload identity information of the calling terminal onto the server.

Preferably, the first link information sending module includes a calling identity prompting module.

The calling identity prompting module is configured to prompt the called terminal or a receiving system with the identity information of the calling terminal corresponding to the link information.

Preferably, the called terminal further includes a first playing module.

The first playing module is configured to monitor a received short message, determine whether the short message is used for providing the link information of the audio data, request the audio data from the server based on the link information in a case that the short message is used for providing the link information of the audio data, and play the audio data to the user.

Preferably, the called terminal further includes a second playing module.

The second playing module is configured to start a browser to open a web page to play the audio data by clicking on the link information by the user in a case that the short message used for providing the link information of the audio data is received.

Preferably, the calling monitoring module further includes a duration determining module.

The duration determining module is configured to acquire a call duration of the call which is not connected in a case that the call is not connected, determine whether the call duration of the call exceeds a threshold, and trigger the voice-recording interface of the calling terminal in a case that the call duration of the call exceeds the threshold.

Preferably, the called terminal further includes a popup reminding module.

The popup reminding module is configured to trigger a popup to remind a user in a case that at least two short messages for providing the link information of the audio data are received.

Preferably, the link information sending module includes a first link information sending module.

The first link information sending module is configured to send the link information to the called terminal in a form of short message by calling a short-message interface in a third-layer protocol of the GSM or the CDMA.

### Fifteenth Embodiment

With reference to FIG. 15, which is a schematic structural diagram of a system for leaving a message according to the disclosure, the system for leaving the message includes a server 1550 and a calling terminal 1500. The calling terminal 1500 includes a call monitoring module 1502, a voice-recording interface starting module 1504, a voice-recording module 1506 and a recorded voice data sending module 1508.

The call monitoring module 1502 is configured to, after a user starts a call process, monitor a connection process of a call made from a calling terminal to a called terminal, and determine whether the call is connected.

The voice-recording interface starting module 1504 is configured to trigger a voice-recording interface of the calling terminal in a case that the call is not connected.

The voice-recording module 1506 is configured to receive a voice input of the user and generate audio data.

The recorded data sending module 1508 includes an uploading module A1510.

The uploading module A1510 is configured to upload the audio data in the calling terminal onto the server via the Internet Protocol.

The server 1550 includes a second link information sending module 1552.

The second link information sending module A1552 is configured to provide link information for the audio data, and send the link information to the called terminal in a form of short message.

Preferably, the recorded voice data sending module includes an identity information uploading module.

The identity information uploading module is configured to upload identity information of the calling terminal onto the server.

Preferably, the second link information sending module includes a calling identity prompting module.

The calling identity prompting module is configured to prompt the called terminal or a receiving system with the identity information of the calling terminal corresponding to the link information.

Preferably, the called terminal further includes a first playing module.

The first playing module is configured to monitor a received short message, determine whether the short message is used for providing the link information of the audio data, request the audio data from the server based on the link information in a case that the short message is used for providing the link information of the audio data, and play the audio data to the user.

Preferably, the called terminal further includes a second playing module.

The second playing module is configured to start a browser to open a web page to play the audio data by clicking on the link information by the user in a case that the short message used for providing the link information of the audio data is received.

### Sixteenth Embodiment

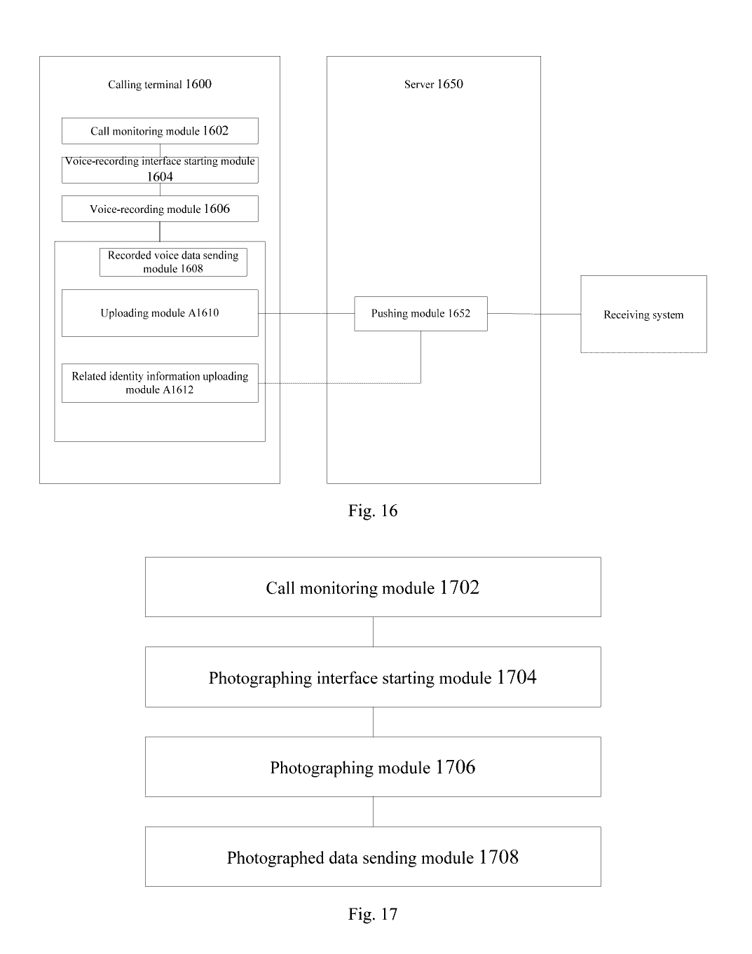

With reference to FIG. 16, which is a schematic structural diagram of a system for leaving a message according to the disclosure, the system for leaving the message includes a server 1650 and a calling terminal 1600. The calling terminal 1600 includes a call monitoring module 1602, a voice-recording interface starting module 1604, a voice-recording module 1606 and a recorded voice data sending module 1608.

The call monitoring module 1602 is configured to, after a user starts a call process, monitor a connection process of a call made from a calling terminal to a called terminal, and determine whether the call is connected.

The voice-recording interface starting module 1604 is configured to trigger a voice-recording interface of the calling terminal in a case that the call is not connected.

The voice-recording module 1606 is configured to receive a voice input of the user and generate audio data.

The recorded data sending module 1608 includes an uploading module A1610 and a related identity information uploading module A1612.

The uploading module A1610 is configured to upload the audio data in the calling terminal onto the server via the Internet Protocol.

The related identity information uploading module A1612 is configured to upload at least one kind of identity information related to the called terminal onto the server.

The server 1650 includes a pushing module 1652.

The pushing module 1652 is configured to store the audio data by the server, and send link information of the audio data to a receiving system corresponding to the identity information.

Correspondingly, the called terminal includes an acquiring module.

The acquiring module is configured to play the audio data or download the audio data from the server in a case that the link information is acquired via the receiving system by the called terminal.

Preferably, the identity information includes a physical address and/or a network address related to the called terminal. The physical address includes at least one of a phone number, an IP (Internet Protocol) address, a mac (physical) address of the called terminal. The network address includes at least one of an email account and an instant messaging account of the called terminal.

Preferably, the recorded voice data sending module includes an identity information uploading module.

The identity information uploading module is configured to upload identity information of the calling terminal onto the server.

Furthermore, the pushing module includes a calling identity prompting module.

The calling identity prompting module is configured to prompt the called terminal or a receiving system with the identity information of the calling terminal corresponding to the link information.

### Seventeenth Embodiment

With reference to FIG. 17, which is a schematic structural diagram of a system for leaving a message according to the disclosure, the system for leaving the message includes a call monitoring module 1702, a photographing interface starting module 1704, a photographing module 1706 and a photographed data sending module 1708.

The call monitoring module 1702 is configured to, after a user starts a call process, monitor a connection process of a call made from a calling terminal to a called terminal, and determine whether the call is connected.

The photographing interface starting module 1704 is configured to trigger a photographing interface of the calling terminal in a case that the call is not connected.

The photographing module 1706 is configured to receive a photographing input of the user and generate video data or photo data.

The recorded data sending module 1708 is configured to upload the video data or the photo data in the calling terminal onto a server via the Internet Protocol, the server provides the video data or the photo data to the called terminal for playing or downloading.

The call monitoring module further includes a duration determining module.

The duration determining module is configured to acquire a call duration of the call which is not connected in a case that the call is not connected, determine whether the call duration of the call exceeds a threshold, and trigger the photographing interface of the calling terminal in a case that the call duration of the call exceeds the threshold.

The call monitoring module includes a first call monitoring module.

The first call monitoring module is configured to monitor a voice service in a connection management sub layer of the GSM protocol or in an upper entity of the CDMA by calling a phone management API of the of a system, and determine whether the call is connected.

### Eighteenth Embodiment

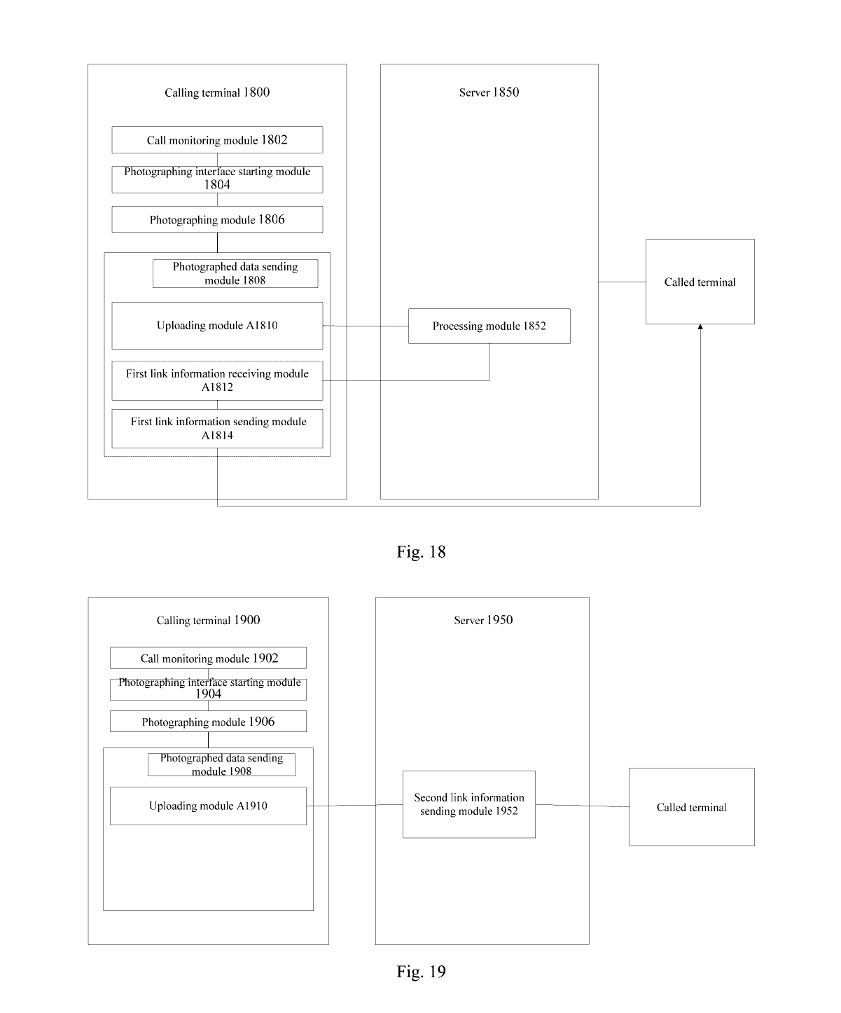

With reference to FIG. 18, which is a schematic structural diagram of a system for leaving a message according to the disclosure, the system for leaving the message includes a server 1850 and a calling terminal 1800. The calling terminal 1800 includes a call monitoring module 1802, a photographing interface starting module 1804, a photographing module 1806 and a photographed data sending module 1808.

The call monitoring module 1802 is configured to, after a user starts a call process, monitor a connection process of a call made from a calling terminal to a called terminal, and determine whether the call is connected.

The photographing interface starting module 1804 is configured to trigger a photographing interface of the calling terminal in a case that the call is not connected.

The photographing module 1806 is configured to receive a photographing input of the user and generate video data or photo data.

The photographed data sending module 1808 includes an uploading module A1810, a first link information receiving module A1812 and a first link information sending module A1814.

The uploading module A1810 is configured to upload the video data or the photo data in the calling terminal onto the server via the Internet Protocol.

The first link information receiving module A1812 is configured to receive link information sent by the server.

The first link information sending module A1814 is configured to send the link information to the called terminal in a form of short message.

The server 1850 includes a processing module 1852.

The processing module 1852 is configured to process the video data or the photo data, generate link information corresponding to the video data or the photo data, and return the link information to a client via the Internet Protocol.

Preferably, the photographed data sending module includes an identity information uploading module.

The identity information uploading module is configured to upload identity information of the calling terminal onto the server.

Preferably, the first link information sending module includes a calling identity prompting module.

The calling identity prompting module is configured to prompt the called tellninal or a receiving system with the identity information of the calling terminal corresponding to the link information.

Preferably, the called terminal further includes a first playing module.

The first playing module is configured to monitor a received short message, determine whether the short message is used for providing the link information of the video data or the photo data, request the video data or the photo data from the server based on the link information in a case that the short message is used for providing the link information of the video data or the photo data, and play the video data or the photo data to the user.

Preferably, the called terminal further includes a second playing module.

The second playing module is configured to start a browser to open a web page to play the video data or the photo data by clicking on the link information by the user in a case that the short message used for providing the link information of the video data or the photo data is received.

Preferably, the calling monitoring module further includes a duration determining module.

The duration determining module is configured to acquire a call duration of the call which is not connected in a case that the call is not connected, determine whether the call duration of the call exceeds a threshold, and trigger the photographing interface of the calling terminal in a case that the call duration of the call exceeds the threshold.

Preferably, the called terminal further includes a popup reminding module.

The popup reminding module is configured to trigger a popup to remind a user in a case that at least two short messages for providing the link information of the video data or the photo data are received.

Preferably, the link information sending module includes a first link information sending module.

The first link information sending module is configured to send the link information to the called terminal in a form of short message by calling a short-message interface in a third-layer protocol of the GSM or the CDMA.

### Nineteenth Embodiment

With reference to FIG. 19, which is a schematic structural diagram of a system for leaving a message according to the disclosure, the system for leaving the message includes a server 1950 and a calling terminal 1900. The calling terminal 1900 includes a call monitoring module 1902, a photographing interface starting module 1904, a photographing module 1906 and a photographed data sending module 1908.

The call monitoring module 1902 is configured to, after a user starts a call process, monitor a connection process of a call made from a calling terminal to a called terminal, and determine whether the call is connected.

The photographing interface starting module 1904 is configured to trigger a photographing interface of the calling terminal in a case that the call is not connected.

The photographing module 1906 is configured to receive a photographing input of the user and generate video data or photo data.

The photographed data sending module 1908 includes an uploading module A1910.

The uploading module A1910 is configured to upload the video data or the photo data in the calling terminal onto the server via the Internet Protocol.

The server 1950 includes a second link information sending module 1952.

The second link information sending module A1952 is configured to provide link information for the video data or the photo data, and send the link information to the called terminal in a form of short message.

Preferably, the photographed data sending module includes an identity information uploading module.

The identity information uploading module is configured to upload identity information of the calling terminal onto the server.

Preferably, the second link information sending module includes a calling identity prompting module.

The calling identity prompting module is configured to prompt the called terminal or a receiving system with the identity information of the calling terminal corresponding to the link information.

Preferably, the called terminal further includes a first playing module.

The first playing module is configured to monitor a received short message, determine whether the short message is used for providing the link information of the video data or the photo data, request the video data or the photo data from the server based on the link information in a case that the short message is used for providing the link information of the video data or the photo data, and play the video data or the photo data to the user.

Preferably, the called terminal further includes a second playing module.

The second playing module is configured to start a browser to open a web page to play the video data or the photo data by clicking on the link information by the user in a case that the short message used for providing the link information of the video data or the photo data is received.

### Twentieth Embodiment

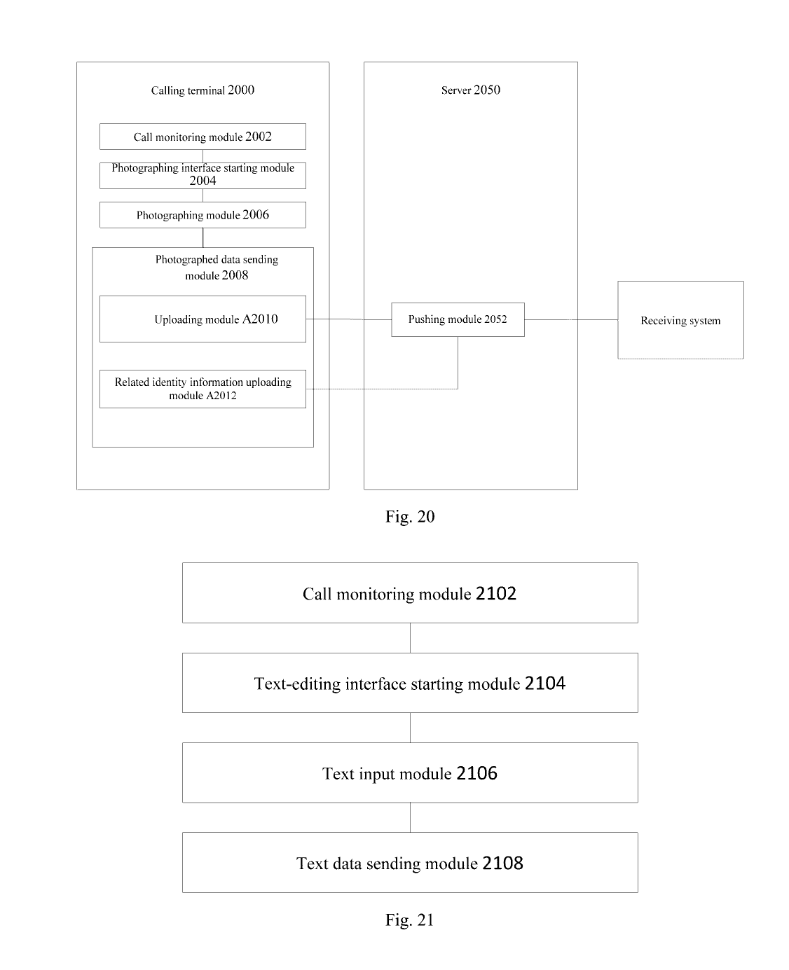

With reference to FIG. 20, which is a schematic structural diagram of a system for leaving a message according to the disclosure, the system for leaving the message includes a server 2050 and a calling terminal 2000. The calling terminal 2000 includes a call monitoring module 2002, a photographing interface starting module 2004, a photographing module 2006 and a photographed data sending module 2008.

The call monitoring module 2002 is configured to, after a user starts a call process, monitor a connection process of a call made from a calling terminal to a called terminal, and determine whether the call is connected.

The photographing interface starting module 2004 is configured to trigger a photographing interface of the calling terminal in a case that the call is not connected.

The photographing module 2006 is configured to receive a photographing input of the user and generate video data or photo data.

The photographed data sending module 2008 includes an uploading module A2010 and a related identity information uploading module A2012.

The uploading module A2010 is configured to upload the video data or photo data in the calling terminal onto the server via the Internet Protocol.

The related identity information uploading module A2012 is configured to upload at least one kind of identity information related to the called terminal onto the server.

The server 2050 includes a pushing module 2052.

The pushing module 2052 is configured to store the video data or the photo data by the server, and send link information of the video data or the photo data to a receiving system corresponding to the identity information.

Correspondingly, the called terminal includes an acquiring module.

The acquiring module is configured to play the video data or the photo data or download the video data or the photo data from the server in a case that the link information is acquired via the receiving system by the called terminal.

Preferably, the identity information includes a physical address and/or a network address related to the called terminal. The physical address includes at least one of a phone number, an IP (Internet Protocol) address, a mac (physical) address of the called terminal. The network address includes at least one of an email account and an instant messaging account of the called terminal.

Preferably, the photographed data sending module includes an identity information uploading module.

The identity information uploading module is configured to upload identity information of the calling terminal onto the server.

Furthermore, the pushing module includes a calling identity prompting module.

The calling identity prompting module is configured to prompt the called terminal or a receiving system with the identity information of the calling terminal corresponding to the link information.

### Twenty-First Embodiment

With reference to FIG. 21, which is a schematic structural diagram of a system for leaving a message according to the disclosure, the system for leaving the message includes a call monitoring module 2102, a text-editing interface starting module 2104, a text input module 2106 and a text data sending module 2108.

The call monitoring module 2102 is configured to, after a user starts a call process, monitor a connection process of a call made from a calling terminal to a called terminal, and determine whether the call is connected.

The text-editing interface starting module 2104 is configured to trigger a text-editing interface of the calling terminal in a case that the call is not connected.

The photographing module 2106 is configured to receive a text input of the user and generate text data.

The recorded data sending module 2108 is configured to upload the text data in the calling terminal onto a server via the Internet Protocol, the server provides the text data to the called terminal for playing or downloading.

The call monitoring module further includes a duration determining module.

The duration determining module is configured to acquire a call duration of the call which is not connected in a case that the call is not connected, determine whether the call duration of the call exceeds a threshold, and trigger the text-editing interface of the calling terminal in a case that the call duration of the call exceeds the threshold.

The call monitoring module includes a first call monitoring module.

The first call monitoring module is configured to monitor a voice service in a connection management sub layer of the GSM protocol or in an upper entity of the CDMA by calling a phone management API of the of a system, and determine whether the call is connected.

### Twenty-Second Embodiment

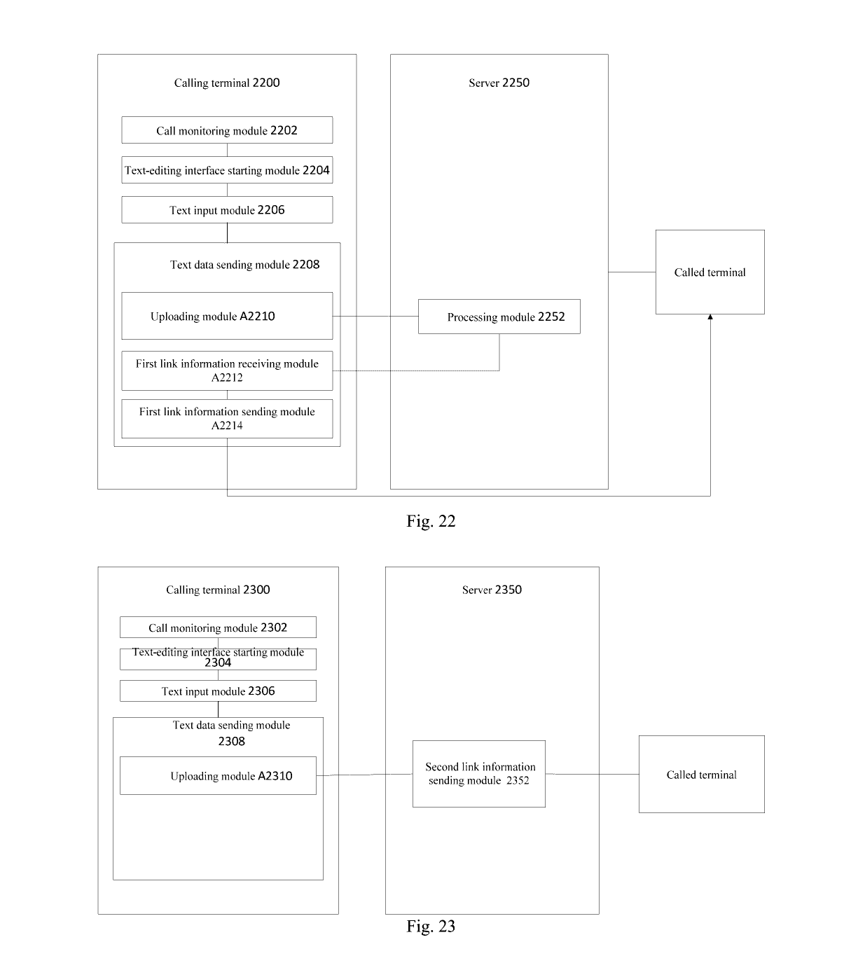

With reference to FIG. 22, which is a schematic structural diagram of a system for leaving a message according to the disclosure, the system for leaving the message includes a server 2250 and a calling terminal 2200. The calling terminal 2200 includes a call monitoring module 2202, a text-editing interface starting module 2204, a text input module 2206 and a text data sending module 2208.

The call monitoring module 2202 is configured to, after a user starts a call process, monitor a connection process of a call made from a calling terminal to a called terminal, and determine whether the call is connected.

The text-editing interface starting module 2204 is configured to trigger a text-editing interface of the calling terminal in a case that the call is not connected.

The text input module 2206 is configured to receive a text input of the user and generate text data.

The text data sending module 2208 includes an uploading module A2210, a first link information receiving module A2212 and a first link information sending module A2214.

The uploading module A2210 is configured to upload the text data in the calling terminal onto the server via the Internet Protocol.

The first link information receiving module A2212 is configured to receive link information sent by the server.

The first link information sending module A2214 is configured to send the link information to the called terminal in a form of short message.

The server 2250 includes a processing module 2252.

The processing module 2252 is configured to process the text data, generate link information corresponding to the text data, and return the link information to a client via the Internet Protocol.

Preferably, the text data sending module includes an identity information uploading module.

The identity information uploading module is configured to upload identity information of the calling terminal onto the server.

Preferably, the first link information sending module includes a calling identity prompting module.

The calling identity prompting module is configured to prompt the called terminal or a receiving system with the identity information of the calling terminal corresponding to the link information.

Preferably, the called terminal further includes a first playing module.

The first playing module is configured to monitor a received short message, determine whether the short message is used for providing the link information of the text data, request the text data from the server based on the link information in a case that the short message is used for providing the link information of the text data, and play the text data to the user.

Preferably, the called terminal further includes a second playing module.

The second playing module is configured to start a browser to open a web page to play the text data by clicking on the link information by the user in a case that the short message used for providing the link information of the text data is received.

Preferably, the calling monitoring module further includes a duration determining module.

The duration determining module is configured to acquire a call duration of the call which is not connected in a case that the call is not connected, determine whether the call duration of the call exceeds a threshold, and trigger the text-editing interface of the calling terminal in a case that the call duration of the call exceeds the threshold.

Preferably, the called terminal further includes a popup reminding module.

The popup reminding module is configured to trigger a popup to remind a user in a case that at least two short messages for providing the link information of the text data are received.

Preferably, the link information sending module includes a first link information sending module.

The first link information sending module is configured to send the link information to the called terminal in a form of short message by calling a short-message interface in a third-layer protocol of the GSM or the CDMA.

### Twenty-Third Embodiment

With reference to FIG. 23, which is a schematic structural diagram of a system for leaving a message according to the disclosure, the system for leaving the message includes a server 2350 and a calling terminal 2300. The calling terminal 2300 includes a call monitoring module 2302, a text-editing interface starting module 2304, a text input module 2306 and a text data sending module 2308.

The call monitoring module 2302 is configured to, after a user starts a call process, monitor a connection process of a call made from a calling terminal to a called terminal, and determine whether the call is connected.

The text-editing interface starting module 2304 is configured to trigger a text-editing interface of the calling terminal in a case that the call is not connected.

The text input module 2306 is configured to receive a text input of the user and generate text data.

The text data sending module 2308 includes an uploading module A2310.

The uploading module A2310 is configured to upload the text data in the calling terminal onto the server via the Internet Protocol.

The server 2350 includes a second link information sending module 2352.

The second link information sending module A2352 is configured to provide link information for the text data, and send the link information to the called terminal in a form of short message.

Preferably, the text data sending module includes an identity information uploading module.

The identity information uploading module is configured to upload identity information of the calling terminal onto the server.

Preferably, the second link information sending module includes a calling identity prompting module.

The calling identity prompting module is configured to prompt the called terminal or a receiving system with the identity information of the calling terminal corresponding to the link information.

Preferably, the called terminal further includes a first playing module.

The first playing module is configured to monitor a received short message, determine whether the short message is used for providing the link information of the text data, request the text data from the server based on the link information in a case that the short message is used for providing the link information of the text data, and play the text data to the user.

Preferably, the called terminal further includes a second playing module.

The second playing module is configured to start a browser to open a web page to play the text data by clicking on the link information by the user in a case that the short message used for providing the link information of the text data is received.

### Twentieth-Fourth Embodiment

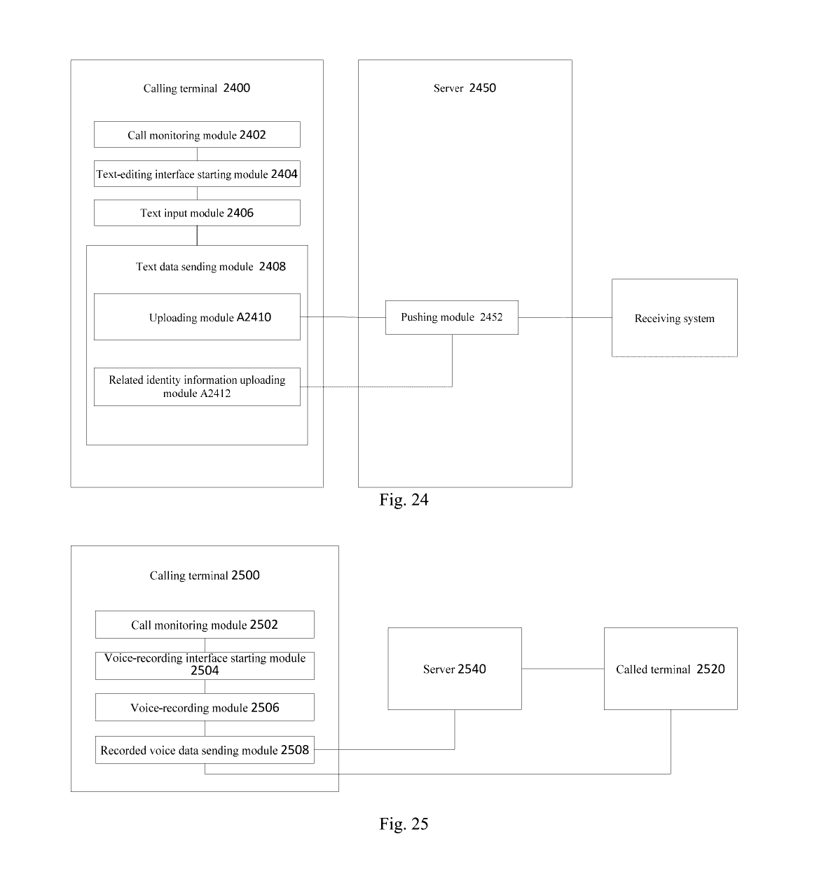

With reference to FIG. 24, which is a schematic structural diagram of a system for leaving a message according to the disclosure, the system for leaving the message includes a server 2450 and a calling terminal 2400. The calling terminal 2400 includes a call monitoring module 2402, a text-editing interface starting module 2404, a text input module 2406 and a text data sending module 2408.

The call monitoring module 2402 is configured to, after a user starts a call process, monitor a connection process of a call made from a calling terminal to a called terminal, and determine whether the call is connected.

The text-editing interface starting module 2404 is configured to trigger a text-editing interface of the calling terminal in a case that the call is not connected.

The text input module 2406 is configured to receive a text input of the user and generate text data.

The text data sending module 2408 includes an uploading module A2410 and a related identity information uploading module A2412.

The uploading module A2410 is configured to upload the text data in the calling terminal onto the server via the Internet Protocol.

The related identity information uploading module A2412 is configured to upload at least one kind of identity information related to the called terminal onto the server.

The server 2450 includes a pushing module 2452.

The pushing module 2452 is configured to store the text data by the server, and send link information of the text data to a receiving system corresponding to the identity information.

Correspondingly, the called terminal includes an acquiring module.

The acquiring module is configured to play the text data or download the text data from the server in a case that the link information is acquired via the receiving system by the called terminal.

Preferably, the identity information includes a physical address and/or a network address related to the called terminal. The physical address includes at least one of a phone number, an IP (Internet Protocol) address, a mac (physical) address of the called terminal. The network address includes at least one of an email account and an instant messaging account of the called terminal.

Preferably, the text data sending module includes an identity information uploading module.

The identity information uploading module is configured to upload identity information of the calling terminal onto the server.

Furthermore, the pushing module includes a calling identity prompting module.

The calling identity prompting module is configured to prompt the called terminal or a receiving system with the identity information of the calling terminal corresponding to the link information.

### Twenty-Fifth Embodiment

With reference to FIG. 25, which is a schematic structural diagram of a system for leaving a message according to the disclosure, the system for leaving the message includes a calling terminal 2500, a called terminal 2520 and a server 2540.

The calling terminal 2500 includes a call monitoring module 2502, a voice-recording interface starting module 2504, a voice-recording module 2506 and a recorded voice data sending module 2508.

The call monitoring module 2502 is configured to, after a user starts a call process, monitor a connection process of a call made from a calling terminal to a called terminal, and determine whether the call is connected.

The voice-recording interface starting module 2504 is configured to trigger a voice-recording interface of the calling terminal in a case that the call is not connected.

The voice-recording module 2506 is configured to receive a voice input of the user and generate audio data.

The recorded data sending module 2508 is configured to upload the audio data onto the server via the Internet Protocol in a case that the user determines to send the audio data to the called terminal. The server provides the audio data to the called terminal for playing or downloading.

Systems for leaving video data, photo data or text data are similar to the system for leaving the audio data, which are not described in detail.

The algorithm and display provided here have no inherent relation with any specific computer, virtual system or other devices. Various general-purpose systems can be used together with the teaching based on this. According to the description above, the structure required to construct this kind of system is obvious. Besides, the disclosure is not directed at any specific programming language. It should be understood that various programming language can be used for achieving the content of the disclosure described here, and above description of specific language is for disclosing the optimum embodiment of the disclosure.

The description provided here explains plenty of details. However, it can be understood that the embodiments of the disclosure can be implemented without these specific details. The known methods, structure and technology are not shown in detail in some embodiments, so as not to obscure the understanding of the description.

Similarly, it should be understood that in order to simplify the disclosure and help to understand one or more of the various aspects of the disclosure, the various features of the disclosure are sometimes grouped into a single embodiment, drawing, or description thereof. However, the method disclosed should not be explained as reflecting the following intention: that is, the disclosure sought for protection claims more features than the features clearly recorded in every claim. To be more precise, as is reflected in the following claims, the aspects of the disclosure are less than all the features of a single embodiment disclosed before. Therefore, the claims complying with a specific embodiment are explicitly incorporated into the specific embodiment thereby, wherein every claim itself as an independent embodiment of the disclosure.

Those skilled in the art can understand that adaptive changes can be made to the modules of the devices in the embodiment and the modules can be installed in one or more devices different from the embodiment. The modules or units or elements in the embodiment can be combined into one module or unit or element, and furthermore, they can be separated into more sub-modules or sub-units or sub-elements. Except such features and/or process or that at least some in the unit are mutually exclusive, any combinations can be adopted to combine all the features disclosed by the description (including the attached claims, abstract and figures) and any method or all process of the device or unit disclosed as such. Unless there is otherwise explicit statement, every feature disclosed by the present description (including the attached claims, abstract and figures) can be replaced by substitute feature providing the same, equivalent or similar purpose.

In addition, a person skilled in the art can understand that although some embodiments described here comprise some features instead of other features included in other embodiments, the combination of features of different embodiments means falling into the scope of the disclosure and forming different embodiments. For example, in the following claims, any one of the embodiments sought for protection can be used in various combination modes.

The various components embodiments of the disclosure can be realized by hardware, or realized by software modules running on one or more processors, or realized by combination thereof. A person skilled in the art should understand that microprocessor or digital signal processor (DSP) can be used for realizing some or all functions of some or all components of the device for leaving the message according to the embodiments in the disclosure in practice. The disclosure can also realize one part of or all devices or system programs (for example, computer programs and computer program products) used for carrying out the method described here. Such programs for realizing the disclosure can be stored in computer readable medium, or can possess one or more forms of signal. Such signals can be downloaded from the Internet website or be provided at signal carriers, or be provided in any other forms.

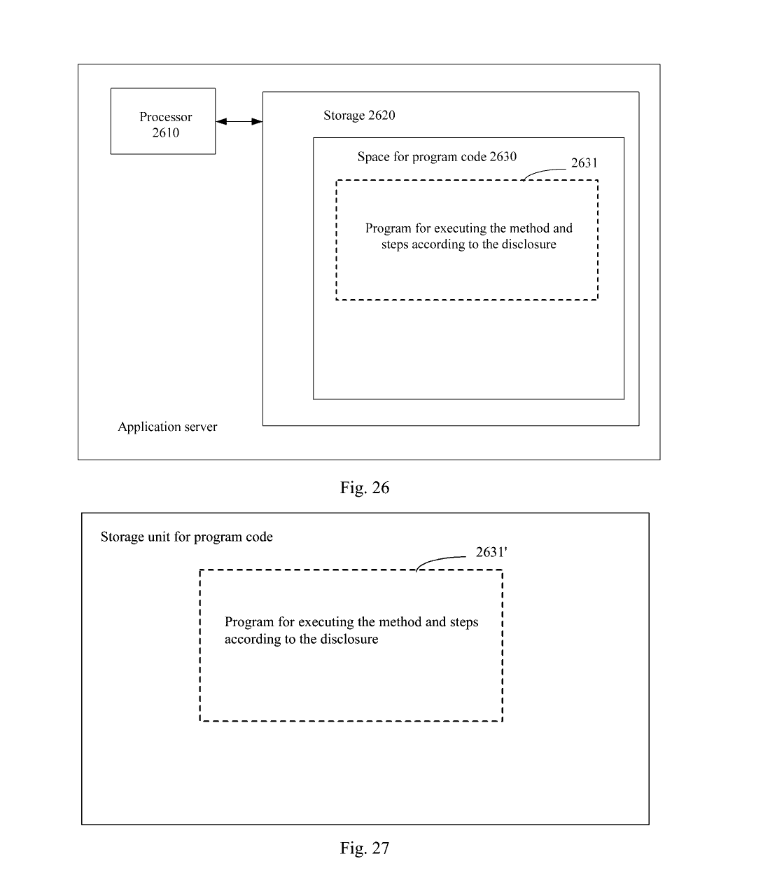

For example, FIG. 26 shows a diagram for a server for implementing the method for leaving the message according to the disclosure, for example, an application server. The server traditionally comprises a processor 2610 and a computer program product in the form of storage 2620 or a computer readable medium. The storage 2620 can be electronic storage such as flash memory, EEPROM (Electrically Erasable Programmable Read—Only Memory), EPROM, hard disk or ROM, and the like. The storage 2620 possesses storage space 2630 for carrying out procedure code 2631 of any steps of aforesaid method. For example, storage space 2630 for procedure code can comprise various procedure codes 2631 used for realizing any steps of aforesaid method. These procedure codes can be read out from one or more computer program products or write in one or more computer program products. The computer program products comprise procedure code carriers such as hard disk, Compact Disc (CD), memory card or floppy disk and the like. These computer program products usually are portable or fixed storage cell as said in FIG. 27. The storage cell can possess memory paragraph, storage space like the storage 2620 in the computing device in FIG. 26. The procedure code can be compressed in, for example, a proper form. Generally, storage cell comprises computer readable code 2631′, i.e. the code can be read by processors such as 2610 and the like. When the codes run on a computer device, the computer device will carry out various steps of the method described above.

The “an embodiment”, “embodiments” or “one or more embodiments” referred here mean being included in at least one embodiment in the disclosure combining specific features, structures or characteristics described in the embodiments. In addition, please note that the phrase “in an embodiment” not necessarily mean a same embodiment.

A lot of details are illustrated in the specification provided here. However, it should be understood that the embodiments of the disclosure can be practiced without the specific details. In some embodiments, a known method, structure and technology are not illustrated in detail, in order to not obscure understanding for the specification.

It should be noticed that the embodiments are intended to illustrate the disclosure and not limit this disclosure, and a person skilled in the art can design substitute embodiments without departing from the scope of the appended claims. In the claims, any reference marks between brackets should not be constructed as limit for the claims. The word “comprise” does not exclude elements or steps that are not listed in the claims. The word “a” or “one” before the elements does not exclude that more such elements exist. The disclosure can be realized by means of hardware comprising several different elements and by means of properly programmed computer. In the unit claims several devices are listed, several of the systems can be embodied by a same hardware item. The use of words first, second and third does not mean any sequence. These words can be explained as name.

1-35. (canceled)

36. A method for leaving a message, comprising:
after a user starts a call process, monitoring a connection process of a call made from a calling terminal to a called terminal, and determining whether the call is connected;
triggering a message-inputting interface in the calling terminal when the call is not connected;
receiving a message input of a user and generating message data; and
uploading the message data in the calling terminal onto a server via an Internet Protocol, and providing the message data to the called terminal for playing or downloading.

37. The method according to claim 36, wherein the providing the message data to the called terminal for playing or downloading comprises:
receiving link information sent by the server, wherein the server provides the link information for the message data;
sending, by the calling terminal, the link information to the called terminal in a form of short message.

38. The method according to claim 36, wherein the providing the message data to the called terminal for playing or downloading comprises:
Providing link information for the message data and sending the link information to the called terminal in a form of short message by the server.

39. The method according to claim 36, wherein the uploading the message data in the calling terminal onto the server via the Internet Protocol includes:
uploading, by the calling terminal, at least one kind of identity information related to the called terminal onto the server.

40. The method according to claim 39, wherein the providing the message data to the called terminal for playing or downloading comprises:
storing the message data and sending link information of the message data to a receiving system corresponding to the identity information by the server.

41. The method according to claim 37, further comprising:
by the called terminal, monitoring a received short message, and determining whether the short message is used for providing the link information of the message data; and if the short message is used for providing the link information of the message data, requesting the message data from the server based on the link information and playing the message data to the user.

42. The method according to claim 38, further comprising:
by the called terminal, monitoring a received short message, and determining whether the short message is used for providing the link information of the message data; and if the short message is used for providing the link information of the message data, requesting the message data from the server based on the link information and playing the message data to the user.

43. The method according to claim 37, further comprising:
by the called terminal, starting a browser to open a web page to play the message data according to clicking on the link information by the user in a case that a short message for providing the link information of the message data is received.

44. The method according to claim 38, further comprising:
by the called terminal, starting a browser to open a web page to play the message data according to clicking on the link information by the user in a case that a short message for providing the link information of the message data is received.

45. The method according to claim 36, wherein the message-inputting interface is any one of a voice-recording interface, a photographing interface and a text-editing interface.

46. A terminal for leaving a message, comprising:
one or more processors; and
a memory;
wherein one or more programs are stored in the memory, and when executed by the one or more processors, the one or more programs cause the one or more processors to:
after a user starts a call process, monitoring a connection process of a call made from the terminal to a called terminal, and determining whether the call is connected, wherein the terminal is configured to be a calling terminal;
triggering a message-inputting interface in the calling terminal when the call is not connected;
receiving a message input of a user and generating message data; and
uploading the message data in the calling terminal onto a server via an Internet Protocol, and providing the message data to the called terminal for playing or downloading.

47. A system for leaving a message, comprising a calling terminal, a called terminal and a server; the calling terminal comprises one or more processors and a memory,
wherein one or more programs are stored in the memory, and when executed by the one or more processors, the one or more programs cause the one or more processors to:
after a user starts a call process, monitoring a connection process of a call made from the terminal to a called terminal, and determining whether the call is connected, the terminal being a calling terminal;
triggering a message-inputting interface in the calling terminal when the call is not connected;
receiving a message input of a user and generating message data; and
uploading the message data in the calling terminal onto a server via an Internet Protocol, and providing the message data to the called terminal for playing or downloading.

48. The system according to claim 47, wherein the one or more processors are further configured to:
receiving link information sent by the server, wherein the server provides the link information for the message data;
sending the link information to the called terminal in a form of short message.

49. The system according to claim 47, wherein the server is configured to:
Providing link information for the message data and sending the link information to the called terminal in a form of short message.

50. The system according to claim 47, wherein the one or more processors are further configured to:
uploading at least one kind of identity information related to the called terminal onto the server.

51. The system according to claim 50, wherein the server is configured to:
storing the message data and sending link information of the message data to a receiving system corresponding to the identity information.

52. The system according to claim 47, wherein the called terminal comprising a second processor and a second memory;
wherein a program are stored in the second memory, and when executed by the second processor, the program cause the second processor to:
monitoring a received short message, and determining whether the short message is used for providing the link information of the message data;
and if the short message is used for providing the link information of the message data, requesting the message data from the server based on the link information and playing the message data to the user.

53. The system according to claim 47, wherein the second processor is further configured to:
starting a browser to open a web page to play the message data according to clicking on the link information by the user in a case that a short message for providing the link information of the message data is received.

54. The system according to claim 48, wherein the second processor is further configured to:
starting a browser to open a web page to play the message data according to clicking on the link information by the user in a case that a short message for providing the link information of the message data is received.

55. The system according to claim 47, wherein the message-inputting interface is any one of a voice-recording interface, a photographing interface and a text-editing interface.
